(19) United States
(12) Patent Application Publication
(10) Pub. No.: US 2014/0162863 A1
(43) Pub. Date: Jun. 12, 2014

(54) HIGH VISIBLE TRANSMISSION GLASSES WITH LOW SOLAR TRANSMISSION

(71) Applicant: ASAHI GLASS COMPANY, LIMITED, Tokyo (JP)

(72) Inventors: Darryl J. Costin, Westlake, OH (US); Harold Haller, Rocky River, OH (US); Clarence Martin, Gahanna, OH (US); Yuki Kondo, Tokyo (JP); Yuya Shimada, Tokyo (JP); Jun Sasai, Tokyo (JP)

(73) Assignee: ASAHI GLASS COMPANY, LIMITED, Tokyo (JP)

(21) Appl. No.: 13/706,474

(22) Filed: Dec. 6, 2012

(51) Int. Cl. C03C 4/02; C03C 3/097; C03C 3/095

(52) U.S. Cl. CPC C03C 4/02; C03C 3/095; C03C 3/097
USPC 501/63; 501/11; 501/64

(57) ABSTRACT

Glasses are described which have characteristics that produce high visible transmittance, low solar transmittance, and high selectivity. The glasses can also preferably have a blue-green color. A number of advantageous formulations are described.

### BACKGROUND

In recent years, there has been a heightened interest in solar control glass with reduced solar transmission for automotive and residential markets. Greater use of solar control glass in autos, homes and buildings could likely save over a hundred million tons of CO₂ emissions annually. Of course, the energy savings from greater use of such solar control glasses would be significant on a worldwide basis and dramatically reduce total energy requirements.

Consequently, there has been significant emphasis in developing improved solar control products with reduced solar transmission for these industries.

In the prior art, there have been two principal means to reduce the solar transmission of glass. The first method is to deposit physical or chemical vapor deposition coating stacks on the glass that allow the transmission of visible light but reflect the solar radiation. The remaining solar energy is then transmitted through the glass, where a small part of the energy is absorbed and a smaller part of the energy is re-radiated back out of the glass. Such coatings unfortunately substantially increase the price of the base glass, often tripling or quadrupling the cost. Further, such coatings generally require some form of protection because the coatings are not by themselves durable.

The second method to reduce solar transmission in glass is through chemical modifications to the base glass chemistry to achieve higher near infrared absorption. The limitation in using traditional solar absorbing glasses in reducing solar transmission is that dopants that typically exhibit absorption bands in the near infrared portion of the spectrum also exhibit absorption in the visible portion of the spectrum. The extent of this issue is reduced for the development of privacy glass and some commercial building glass products where the visible transmission requirements are as low as 25%. Compounds, which exhibit absorption bands in the ultraviolet and/or near Infrared parts of the electromagnetic spectrum but also exhibit absorption bands in the visible spectrum, can be used to reduce the solar transmission of such low visible transmission glasses. Such compounds, for example, include Fe₂O₃, NiO, V₂O₅, CoO, MnO₂, Cr₂O₃, etc. Hence, there are many compounds singularly and in combination to select for altering the glass chemistry in order to achieve reduced solar transmission, albeit at reduced visible transmission.

However, the development of reduced solar transmission for high visible transmission glass products such as those for automotive glass (windshields and sidelights in front of the B pillar) and residential windows is substantially more difficult, since these glasses must be durable; and since significantly reduced visible transmission is not a viable option.

As a result, there have been no significant advancements in reducing the solar transmission of commercial glasses for automotive windshields and sidelights or for residential homes. For the last two decades, automotive glass has not been able to achieve a solar transmission less than 40% and for the most part, the solar transmission for current commercial automotive glasses is typically about 42%. The solar transmission for window glass (with a visible transmission of 80% or so) without a coating is typically greater than 60%. The authors have addressed this problem by inventing new revolutionary solar control glasses with significantly lower solar transmission than those products commercially available.

### SUMMARY OF INVENTION

By going against the conventional wisdom, the authors conceived of a new technical approach to realizing significantly improved solar performance for high visible transmission glass from chemistry modifications.

Embodiments describe the use of optimization models based on transmission data. This differs from the conventional method of utilizing absorption or optical density data for modeling solar-optical properties as a function of glass batch chemistry. Surprisingly, this approach resulted in the invention of several high visible transmission glasses with reduced solar transmission with properties that have never been able to be achieved in the flat glass industry.

Embodiments describe specific formulations of glass that have unprecedented characteristics including visible transmission greater than 69%, and solar transmissions less than 50%. All of this, with an attractive blue-green color. Embodiments also described the selectivity defined by a difference between a visible transmission in the solar transmission of greater than 31.5.

### BRIEF DESCRIPTION OF THE DRAWINGS

In the Drawings:

The patent or application file contains at least one drawing executed in color. Copies of this patent or patent application publication with color drawing(s) will be provided by the Office upon request and payment of the necessary fee.

FIG. 1 shows a flowchart of the authors' software;

FIG. 2 shows an embodiment of an example of the results from an analysis;

FIG. 3 shows transmittance curves according to an embodiment; and

FIG. 4 shows graphs of predicted vs actual.

### DETAILED DESCRIPTION

In order to carry out the different experiments described herein, the authors used computer programs, which is first described. While the computer programs have certain characteristics as described herein, it should be understood that other optimizations could be carried out using different programs. The important part of the computer programs described herein is its ability to carry out these functions, and different computer programs can also be used.

HPGI's proprietary modeling package, D-Optimal Software Suite, consists of the following software programs that work together to provide optimum solutions to product development and process improvement:

a. D-Optimal Matrix Creator is used to develop a set of experiments that provides the maximum amount of information for a given number of experiments and that develop an appropriate design that allows for statistical modeling of the results.

b. Multivariate Statistical Modeler allows for input of results from the D-Optimal Matrix Creator of experiments for the development of regression equations or correlation models that quantitatively relate the response variables to the independent variables and their interactions.

c. Discrete Response Integrator is a unique custom program that calculates optical densities at individual wavelengths from regression equations whose coefficients have been calculated by the Multivariate Statistical Modeler, transforms the optical densities into transmittances and then computes integrated properties such as visible transmission, solar transmission and color properties from the resulting transmission curves. For less complex relationships, the regression equations can be imported directly into Non Linear Property Optimizer.

d. Non Linear Property Optimizer is a custom program that accepts the input from the Discrete Response Integrator or the Multivariate Statistical Modeler to identify optimum properties such as minimum solar transmission at any number of constraints such as visible transmission and color properties. Non Linear Property Optimizer also includes a goal programming feature to simultaneously pursue coming as close as possible to multiple desired properties. We used two versions of the optimization program. The first version, allows for the user to enter the regression equations directly into the software program and determine optimum properties for response variables that are conflicting. The second version is a custom program that HPGI develops (usually within one week of development) that provides the user with a simple to use “push-button” optimization program and prediction program in one application.

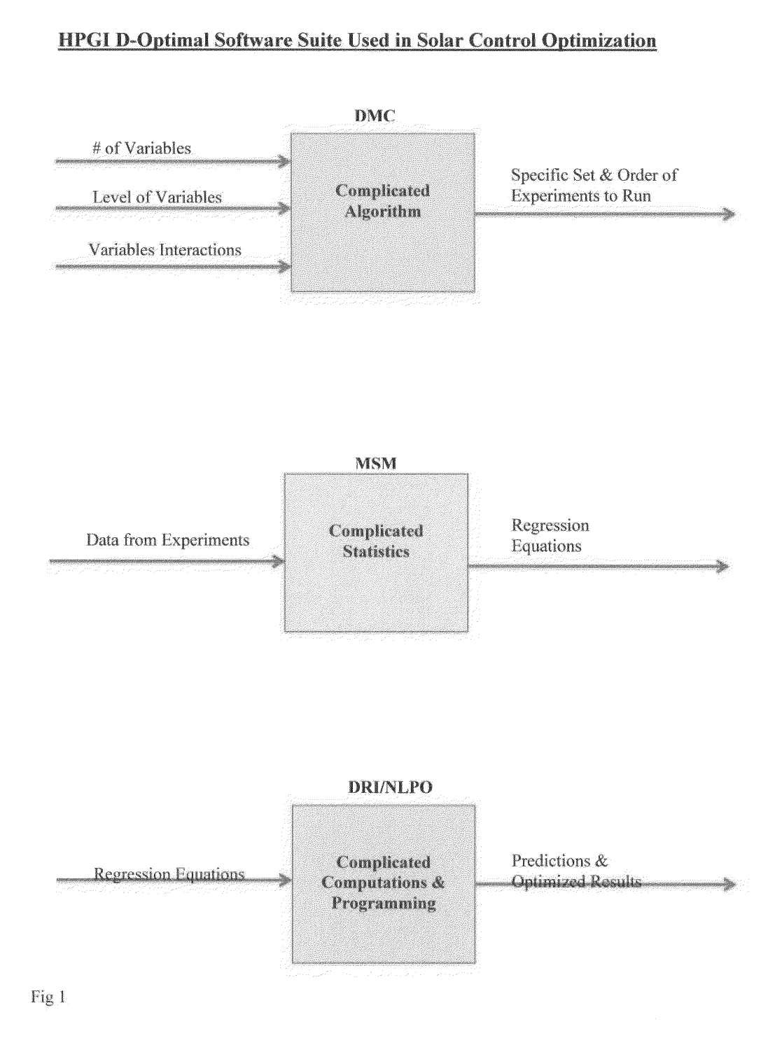

FIG. 1 shows a flowchart of the software, including the different software modules which operate together to create the optimized results which are obtained herein.

The authors formulated optimum solutions to product development and process improvement. In an embodiment, this used the optimization modeling software suite called D-Optimal Software Suite and described above.

A first embodiment used the D-Optimal Matrix Creator (DMC) is used to develop a set of experiments that provides the maximum amount of information for a given number of experiments and that develop an appropriate design that allows for statistical modeling of the results.

Multivariate Statistical Modeler (MSM) allows for input of results from the D-Optimal Matrix Creator of experiments for the development of regression equations or correlation models that quantitatively relate the response variables to the independent variables and their interactions. For each of these experiments and values, the Non Linear Property Optimizer (NLPO) calculates, for any values of the glass batch chemistry, transmittances for the wavelengths for which MSM has determined regression equations. Simultaneously, integrated values such as visible transmission, solar transmission and color properties are calculated from the transmission values based on weighting factors as specified standards by ISO and JIS.

The optimization capability allows the user to specify an objective function to be minimized (e.g., solar transmission) or maximized (e.g., visible transmission and selectivity) subject to restrictions such as limits on visible transmission, solar transmission, color properties, batching constraints, and upper and lower limits on individual components of the glass batch chemistry. The software then employs the generalized reduced gradient method to determine the values of the glass batch chemistry that optimizes the specified objective function subject to the constraints.

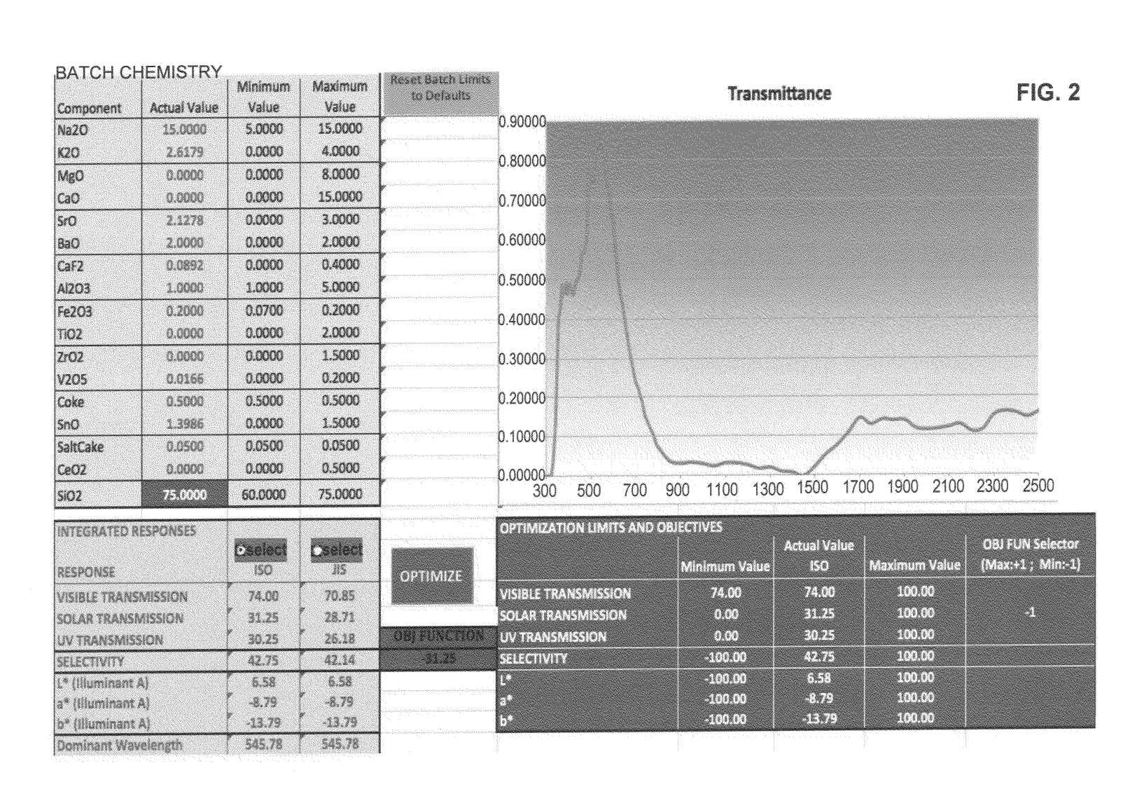

An embodiment of the results from an analysis is shown in FIG. 2.

Again, other software can be used to create these results, and many of the discoveries that are described herein are completely independent of the software that was used.

A description of the specific strategies employed by the authors to invent such revolutionary solar control glasses with high visible transmission but low solar transmission is detailed in the below.

Identify m candidate chemical variables and batching levels for producing glass with revolutionary properties.

Use DMC to design a series of experiments based on D-Optimal logic from which to quantify the effects of the m chemical variables on the optical properties of glass. The quantification operates to minimize the average error of prediction ratio ( E̅O̅P̅R̅) computed from the following equation.

$$\overline{E O P R} = {\sum }_{\underline{x}} \frac{{\underline{x} ( {X}^{T} X )}^{- 1} {\underline{x}}^{T}}{( {3}^{n} - k )}$$

In this equation, X is an n by p matrix of n experiments and p chemical variables, where p is the sum of the m-linear and m-non-linear terms as well as the interactions between these m chemical variables and X^{T} is the p by n transpose of X. The vector x refers to points in the m-dimensional design space, the space of all admissible experiments, 3^{m}−k, where k is the totality of combinations of the chemical variables and batching levels known to be impossible to melt.

Once the data are available from the optical properties (transmittance, color, mechanical properties, and the other parameters described herein) of the glasses melted according to the D-Optimal experimental design, these data were analyzed using MSM. The inventors used a sequential modeling approach, which begins before the entire series of D-Optimal experiments are completed, in order to make mid-course corrections to the experimental strategy should early results from melts indicate regions of the design space heretofore unknown to be avoided and subsequent re-optimization using DMC to be performed using the existing experiments as a starting point combined with new restrictions to the design space.

In one embodiment, the software accounts for each wavelength of transmittance, one of the key optical properties.

The conventional methodology to model solar optical properties of glass is to rely upon the Beer-Lambert Law. Let the intensity of incident light be denoted by I and the change in intensity through glass with dopant level/absorber fact β and thickness dt be dI. In the derivation of the Beer-Lambert equation for a single absorber, β, at a single wavelength, the intensity of the incident light, I₀, is reduced to I after passing through glass of thickness dt, with absorber factor β, which leads to the following differential equation:

dI∝BIdt

where β is related to the amount of absorption of the material and the distance that the light passes through the material.

The assumption is that the change in the intensity, dI, as the light travels through a thickness dt is proportional to the intensity out of the glass according to a logarithmic dependence.

The solution to this equation reduces to the following:

$${log}_{10} ( I ) = β t$$

$$or$$

$$\frac{1}{t} {log}_{10} ( I ) = β .$$

For multiple compounds (each having their own β, this equation generalizes to the following form.

$$- \frac{1}{τ} {log}_{10} [ I ( λ ) ] = {\sum }_{i = 1}^{m} {β ( λ )}_{i} {c}_{i} + {\sum }_{i = 1}^{m} {β ( λ )}_{ii} {c}_{i}^{2} + {\sum }_{i = 1}^{m} {\sum }_{j > i}^{m} {β ( λ )}_{ij} {c}_{i} {c}_{j}$$

The left hand side of this equation is referred to as optical density which is essentially an absorption property.

However, the inventors found, after reviewing many different experiments, what they believe to be a better definition of reliable predictions of the solar optical properties (visible transmission, solar transmission, UV transmission, color, and dominant wavelength) as a function of glass batch chemistry. In fact, the authors developed dozens of regression models correlating the solar optical properties to the glass batch chemistry and found no success with the optical density approach. Based on this, the inventors postulated that the conventional Beer-Lambert law of absorption does not produce good results for modeling high visible transmission glass.

According to an embodiment, the authors conceived of a new approach to modeling high transmission glass as shown below:

The Costin-Martin-Haller law of high transmittance absorption begins with a slightly different differential

equation of the following form:

$$d T = β d t$$

$$where$$

$$T = \frac{I}{{I}_{n}} .$$

Note that this referring to transmittance, rather than intensity. The inventors noted that the change in transmittance as the light of a given wavelength passes through a thickness, dt, of glass is proportional to the absorber dopant factor, β.

This leads to our general model for complex chemistry, where the β's are the unknown absorber factors and

the c's are the known concentrations of each compound from the batch chemistry.

$$T ( λ ) = {\sum }_{i = 1}^{m} {β ( λ )}_{i} {c}_{i} + {\sum }_{i = 1}^{m} {β ( λ )}_{ii} {c}_{i}^{2} + {\sum }_{i = 1}^{m} {\sum }_{j > i}^{m} {β ( λ )}_{ij} {c}_{i} {c}_{j}$$

Where T(λ) is the transmittance at wavelength λ.

This novel relationship surprisingly generated excellent results with reliable predictions. The results were indeed surprising since the Beer Lambert law was based upon a well known physical understanding of absorption. The Costin-Martin-Haller law as described herein is based upon empirical concepts and experimentation. Optimization modeling based upon the regression models developed from the Costin-Martin-Haller concept produced some extraordinary glass products with unprecedented solar optical properties for high visible transmission glass. Further details are described below:

Using MSM and backward elimination logic, models were developed at each wavelength using the Costin-Martin-Haller Law that satisfied the following criteria:

This system uses a statistical term t to determine if a term should be brought in a regression model or if it should stay out. All t-values for variables in the model were greater than the critical value, 2.0 (where critical value is defined here as the absolute value). This led to a situation where if you bring the term in and the statistical significance of all the terms in the model improve, then you keep that term in the model.

All t-values for variables not in the model were less than the critical value 2.0

We also selected only results where practical experiment confirmed the result of the experiment. In one embodiment, the ratio of the square root of the mean square error, S_{y.x}, to the experimental error, S_{experimental error} was required to be less than 1.7. This test demonstrates that the model prediction is not significantly different from the ability to melt the glass and measure the transmittance.

Another criterion relative to the models prior to importing them into NLPO for optimization is to integrate the model equations and compare the resulting predicted visible transmittance (“VT”) and solar transmittance (“ST”) with actual average values from each melt. We obtained 95 regression equations, one for each of the wavelengths from 300 to 400 in steps of 5 nm, from 400 to 800 in steps of 10 nm, and from 800 to 2500 in steps of 50 nm. These equations were numerically integrated using the tabulated weighing factors.

Predicted VT and ST values can be compared to the actual average values by generating a scatter diagram for each and computing the square root of the mean square error, S_{y.x}, for each linear correlation. Any indicated departure from linearity in this correlation (beyond expected experimental limits) indicates that particular series of models from MSM are not suitable for predicting optical properties like VT, ST, and color.

In order to test the hypothesis concerning the S_{y.x} value computed from this correlation in a manner that is consistent with the above, it is necessary to obtain an estimate of S_{experimental error}. This can be accomplished in a different ways.

First, if multiple optical measurements are made on each glass sample from a single melt, then the instrument and within melt standard deviation can be estimated from the following formula.

$${S}_{instrument + within melt} = \sqrt{\frac{{\sum }_{i = 1}^{n} {S}_{instrument + within {melt}_{1}}^{2}}{n}}$$

In this formula, multiple optical measurements (e.g. transmittance) that are made for each glass sample melted are used to compute the variance associated with instrument and within melt sources of variation. The average of these variances over the n experiments results in an estimate of the S_{instrument+within melt} with degrees of freedom equal to n (# measurements per melt−1).

The S_{experimental error} for averages is

$${S}_{expterror for average of 4 measurements} = \sqrt{{S}_{between melt}^{2} + \frac{{S}_{instrument + within melt}^{2}}{4}}$$

Typically S_{between melt} is twice the S_{instrument+within melt} thus the S_{expt. error} for 4 measurements is 2.06 S_{instrument+within melt}.

An alternative to this procedure is to find in the n-experimental matrix, X, “nearest neighbor” experiments that can be used to compute the combination of melt-to-melt, within melt, and instrument variances. These variances are pooled using the same formula above where the degrees of freedom are the sum of the number of nearest neighbor pairs.

When the 95 models for transmittance at each wavelength are integrated to yield predicted VT and ST values and the square root of the mean square error from the correlation between these predicted VT and ST values and average of four VT and ST measurements is less than 1.7 times the computed estimate of S_{expt error for average of 4 measurements} shown above, then the 95 regression equations can be imported into NLPO for optimization.

Of course, some other number of equations can alternatively be used.

Optimization using NLPO by the inventors used a combination of trends seen in various searches and a physical and theoretical understanding of the effects of batch additions of chemicals to the glass melt on the optical properties of glass. Because the development of revolutionary glasses is exploration into new regimes of the experimental design space, trend analysis based on the NLPO results was shown to be more productive than relying on theory or experiential thinking. But confirmation of NLPO trends and results with theory and experience is valuable. This phase of the process leads to several perturbation experiments in the regions of the experimental design space that NLPO shows to yield glass with optimum properties.

Once the results of perturbation experiments are available for analysis, the D-Optimal experiments and the perturbation experiments are combined into a single data set from which 95 updated regression models were developed using the methodology outlined above using MSM, one for each of the wavelengths of transmittance. Models for other optical properties are also updated using the combined D-Optimal and perturbation experiments.

The steps described above, of importing the regression equations into the software for optimization, and then studying those trends, are then repeated. This is done once the models for transmittance have been developed using MSM based on the augmented data following the production of the results from the perturbation experiments. Optimizations using NLPO with the newly generated models for the 95 transmittances lead to finalizing confirmation experiments for various glass applications.

### Application of the Methodology to the Invention of Novel Solar Control Glasses

The application of the methodology described in the previous section and the subsequent results is described below:

Based on reviewing the results of the experiments, it was decided that the following batch variables should be the focus of the experimental investigation in order to develop revolutionary solar control glasses. These materials would be combined according to a D-Optimal designed experiment in each batch to produce glass samples for this study: Na₂O, K₂O, MgO, CaO, SrO, BaO, CaF₂, Al₂O₃, Fe₂O₃, TiO₂, ZrO₂, V₂O₅, Coke, SnO, SaltCake, SiO₂. Unique amongst conventional glass modeling studies, the authors elected to include the base glass variables as well as the dopants in the regression models. The levels for each variable were also determined with the objective to be as inquisitive as physically possible when investigating the experimental design space. Because this is a mixture problem, SiO₂ was selected as the slack variable for purposes of making the batch composition add up to 100 mole percent. The relationship between these design variables and the solar properties of glass was postulated to be linear as well as non-linear.

In this embodiment, the inventors postulated the following interactions being significant: Na₂O*CaO, K₂O*CaO, CaO*Fe₂O₃, Fe₂O₃*TiO₂, Fe₂O₃*ZrO₂, Fe₂O₃*SnO, Fe₂O₃*SaltCake, Fe₂O₃*Coke, Na₂O*CaO* Fe₂O₃, BaO*CaF₂* Fe₂O₃, CaO*BaO* Fe₂O₃, SrO*BaO* Fe₂O₃, SrO*SnO* Fe₂O₃, BaO*SnO* Fe₂O₃, Coke*SnO* Fe₂O₃, Fe₂O₃*Coke*SnO*SaltCake. Thus a D-Optimal DOE was needed for the 15 batch variables that would permit estimation of the 15 linear and non-linear effects as well as the 16 interactions, one for which the EOPR was 1.0.

Using DMC, the following 78-melt D-Optimal DOE was generated based on the 15 batch variables, 15 quadratic effects, and 16 interactions listed above. The average error of prediction ratio for this DOE was approximately 1.0, which means that models for optical properties generated from these data will predict the optical properties as well as these properties can be measured. The batch composition in shown in mole percent.

TABLE 1

| Exp # | 1 | 2 | 3 | 4 | 5 | 6 | 7 | 8 | 9 | 10 |
|---|---|---|---|---|---|---|---|---|---|---|
| SiO2 | 68.30 | 67.91 | 63.12 | 58.54 | 60.39 | 70.71 | 55.34 | 55.50 | 59.73 | 71.45 |
| Al2O3 | 0.00 | 2.70 | 1.52 | 0.00 | 4.71 | 2.82 | 5.00 | 5.00 | 2.79 | 0.00 |
| MgO | 8.00 | 4.00 | 8.00 | 3.38 | 5.88 | 3.97 | 8.00 | 0.00 | 0.00 | 1.34 |
| CaO | 0.00 | 0.00 | 15.00 | 15.00 | 5.85 | 0.00 | 15.00 | 15.00 | 15.00 | 9.64 |
| SrO | 3.00 | 3.00 | 0.00 | 0.00 | 3.00 | 0.00 | 0.00 | 0.00 | 3.00 | 0.00 |
| BaO | 2.00 | 2.00 | 0.00 | 2.00 | 0.91 | 2.00 | 1.00 | 1.20 | 2.00 | 1.61 |
| Na2O | 9.15 | 15.00 | 9.01 | 15.00 | 12.39 | 15.00 | 10.55 | 15.00 | 9.27 | 10.73 |
| K2O | 4.00 | 4.00 | 0.00 | 2.25 | 3.19 | 1.60 | 0.00 | 4.00 | 4.00 | 0.67 |
| CaF2 | 0.40 | 0.00 | 0.00 | 0.16 | 0.00 | 0.40 | 0.17 | 0.40 | 0.40 | 0.40 |
| ZrO2 | 1.05 | 0.00 | 1.50 | 1.50 | 1.50 | 1.50 | 1.50 | 1.50 | 0.00 | 1.13 |
| Fe2O3 | 0.07 | 0.07 | 0.07 | 0.20 | 0.07 | 0.20 | 0.20 | 0.20 | 0.07 | 0.07 |
| TiO2 | 1.34 | 0.00 | 0.00 | 0.98 | 2.00 | 0.00 | 1.47 | 2.00 | 2.00 | 2.00 |
| V2O5 | 0.08 | 0.00 | 0.20 | 0.00 | 0.00 | 0.20 | 0.20 | 0.10 | 0.15 | 0.09 |
| Coke | 1.00 | 0.42 | 0.56 | 1.00 | 0.00 | 0.00 | 0.00 | 0.00 | 0.00 | 0.87 |
| SnO | 1.50 | 0.90 | 0.92 | 0.00 | 0.00 | 1.50 | 1.50 | 0.00 | 1.50 | 0.00 |
| SaltCake | 0.10 | 0.00 | 0.10 | 0.00 | 0.10 | 0.10 | 0.06 | 0.10 | 0.10 | 0.00 |

| Exp # | 11 | 12 | 13 | 14 | 15 | 16 | 17 | 18 | 19 | 20 |
|---|---|---|---|---|---|---|---|---|---|---|
| SiO2 | 63.39 | 68.20 | 64.33 | 66.49 | 64.46 | 75.00 | 72.83 | 54.82 | 54.84 | 64.85 |
| Al2O3 | 5.00 | 2.05 | 0.57 | 2.00 | 1.28 | 0.00 | 0.00 | 2.26 | 2.24 | 0.00 |
| MgO | 8.00 | 8.00 | 8.00 | 0.00 | 4.07 | 0.00 | 6.72 | 4.66 | 8.00 | 6.04 |
| CaO | 0.00 | 0.00 | 14.28 | 9.84 | 15.00 | 0.00 | 0.00 | 15.00 | 15.00 | 15.00 |
| SrO | 0.00 | 3.00 | 0.00 | 3.00 | 1.50 | 2.05 | 1.99 | 3.00 | 3.00 | 0.00 |
| BaO | 2.00 | 0.00 | 2.00 | 0.80 | 0.00 | 0.00 | 2.00 | 0.00 | 0.00 | 0.00 |
| Na2O | 15.00 | 15.00 | 8.02 | 11.28 | 9.15 | 15.00 | 11.41 | 15.00 | 10.00 | 7.43 |
| K2O | 2.16 | 0.00 | 0.98 | 1.23 | 3.17 | 3.59 | 0.00 | 2.00 | 4.00 | 2.17 |
| CaF2 | 0.40 | 0.00 | 0.40 | 0.40 | 0.40 | 0.40 | 0.00 | 0.00 | 0.40 | 0.40 |
| ZrO2 | 1.50 | 0.78 | 0.00 | 1.50 | 0.79 | 0.00 | 1.50 | 0.00 | 0.77 | 0.00 |
| Fc2O3 | 0.07 | 0.12 | 0.20 | 0.14 | 0.07 | 0.07 | 0.07 | 0.20 | 0.20 | 0.20 |
| TiO2 | 0.82 | 0.82 | 0.00 | 0.79 | 0.00 | 2.00 | 2.00 | 0.90 | 0.00 | 2.00 |
| V2O5 | 0.10 | 0.00 | 0.12 | 0.20 | 0.12 | 0.08 | 0.20 | 0.00 | 0.00 | 0.20 |
| Coke | 0.00 | 0.53 | 1.00 | 1.00 | 0.00 | 1.00 | 0.60 | 0.56 | 0.00 | 0.50 |
| SnO | 1.50 | 1.50 | 0.00 | 1.33 | 0.00 | 0.75 | 0.60 | 1.50 | 1.50 | 1.22 |
| SaltCake | 0.05 | 0.00 | 0.10 | 0.00 | 0.00 | 0.06 | 0.09 | 0.10 | 0.05 | 0.00 |

| Exp # | 21 | 22 | 23 | 24 | 25 | 26 | 27 | 28 | 29 | 30 |
|---|---|---|---|---|---|---|---|---|---|---|
| SiO2 | 55.87 | 67.74 | 67.67 | 65.00 | 61.57 | 71.50 | 74.46 | 53.20 | 74.71 | 61.83 |
| Al2O3 | 0.00 | 0.00 | 4.01 | 5.00 | 0.00 | 0.00 | 0.00 | 0.00 | 0.00 | 0.00 |
| MgO | 8.00 | 0.00 | 5.54 | 0.94 | 3.51 | 8.00 | 0.00 | 8.00 | 2.26 | 0.00 |
| CaO | 15.00 | 15.00 | 0.96 | 6.16 | 15.00 | 0.00 | 1.42 | 15.00 | 0.00 | 15.00 |
| SrO | 1.80 | 3.00 | 2.06 | 1.20 | 0.00 | 1.78 | 3.00 | 3.00 | 2.03 | 3.00 |
| BaO | 1.05 | 0.00 | 0.64 | 2.00 | 0.00 | 2.00 | 0.00 | 2.00 | 0.80 | 0.80 |
| Na2O | 12.30 | 8.87 | 15.00 | 15.00 | 15.00 | 10.75 | 15.00 | 12.00 | 15.00 | 15.00 |
| K2O | 1.85 | 4.00 | 0.13 | 0.00 | 0.00 | 2.40 | 1.16 | 0.00 | 0.00 | 4.00 |
| CaF2 | 0.00 | 0.00 | 0.20 | 0.00 | 0.40 | 0.00 | 0.10 | 0.40 | 0.40 | 0.17 |
| ZrO2 | 0.00 | 0.00 | 0.27 | 0.00 | 0.75 | 1.30 | 1.50 | 1.50 | 1.50 | 0.00 |
| Fe2O3 | 0.07 | 0.07 | 0.20 | 0.20 | 0.07 | 0.14 | 0.20 | 0.20 | 0.20 | 0.20 |
| TiO2 | 2.00 | 1.12 | 0.66 | 2.00 | 2.00 | 1.17 | 1.55 | 2.00 | 2.00 | 0.00 |
| V2O5 | 0.07 | 0.10 | 0.14 | 0.00 | 0.20 | 0.20 | 0.10 | 0.20 | 0.00 | 0.00 |
| Coke | 0.45 | 0.00 | 1.00 | 1.00 | 0.00 | 0.00 | 0.00 | 1.00 | 1.00 | 0.00 |
| SnO | 1.50 | 0.00 | 1.50 | 1.50 | 1.50 | 0.75 | 1.50 | 1.50 | 0.00 | 0.00 |
| SaltCake | 0.05 | 0.10 | 0.02 | 0.00 | 0.00 | 0.00 | 0.01 | 0.00 | 0.10 | 0.00 |
| Exp # | 31 | 32 | 33 | 34 | 35 | 36 | 37 | 38 | 39 | 40 |
| SiO2 | 69.18 | 52.84 | 56.08 | 74.14 | 64.63 | 50.31 | 53.61 | 56.55 | 61.25 | 60.08 |
| Al2O3 | 1.59 | 3.11 | 0.00 | 0.00 | 0.00 | 5.00 | 1.98 | 2.09 | 1.84 | 0.00 |
| MgO | 0.00 | 3.52 | 8.00 | 8.00 | 0.00 | 8.00 | 3.00 | 8.00 | 7.91 | 7.51 |
| CaO | 7.50 | 15.00 | 8.62 | 0.00 | 15.00 | 12.97 | 15.00 | 15.00 | 9.88 | 13.24 |
| SrO | 0.00 | 0.00 | 1.47 | 0.00 | 3.00 | 0.00 | 3.00 | 1.50 | 0.44 | 3.00 |
| BaO | 0.00 | 2.00 | 2.00 | 2.00 | 2.00 | 0.00 | 0.00 | 0.00 | 1.81 | 0.88 |
| Na2O | 11.98 | 15.00 | 15.00 | 12.07 | 7.32 | 14.68 | 15.00 | 15.00 | 8.78 | 5.04 |
| K2O | 4.00 | 4.00 | 4.00 | 0.77 | 4.00 | 4.00 | 4.00 | 0.00 | 4.00 | 4.00 |
| CaF2 | 0.00 | 0.00 | 0.40 | 0.00 | 0.25 | 0.00 | 0.40 | 0.22 | 0.32 | 0.00 |
| ZrO2 | 0.85 | 0.66 | 0.73 | 0.75 | 0.00 | 1.50 | 0.00 | 0.00 | 1.50 | 1.28 |
| Fe2O3 | 0.20 | 0.07 | 0.20 | 0.20 | 0.20 | 0.10 | 0.20 | 0.13 | 0.14 | 0.20 |
| TiO2 | 2.00 | 1.00 | 2.00 | 2.00 | 2.00 | 1.87 | 2.00 | 1.21 | 1.59 | 2.00 |
| V2O5 | 0.11 | 0.20 | 0.00 | 0.00 | 0.00 | 0.10 | 0.13 | 0.20 | 0.06 | 0.20 |
| Coke | 1.00 | 1.00 | 0.00 | 0.00 | 0.00 | 0.55 | 1.00 | 0.00 | 0.00 | 1.00 |
| SnO | 1.50 | 1.50 | 1.50 | 0.00 | 1.50 | 0.92 | 0.63 | 0.00 | 0.49 | 1.50 |
| SaltCake | 0.10 | 0.10 | 0.00 | 0.07 | 0.10 | 0.00 | 0.05 | 0.10 | 0.00 | 0.09 |
| Exp # | 41 | 42 | 43 | 44 | 45 | 46 | 47 | 48 | 49 | 50 |
| SiO2 | 58.30 | 75.00 | 72.20 | 64.52 | 58.23 | 57.57 | 64.11 | 57.33 | 60.00 | 60.08 |
| Al2O3 | 5.00 | 0.00 | 0.00 | 5.00 | 5.00 | 5.00 | 3.01 | 5.00 | 0.00 | 0.00 |
| MgO | 0.00 | 7.02 | 4.55 | 8.00 | 0.00 | 0.00 | 0.00 | 4.97 | 8.00 | 8.00 |
| CaO | 15.00 | 0.61 | 0.00 | 0.00 | 15.00 | 15.00 | 10.45 | 15.00 | 13.03 | 15.00 |
| SrO | 1.39 | 3.00 | 1.47 | 0.00 | 1.80 | 3.00 | 3.00 | 0.00 | 3.00 | 3.00 |
| BaO | 2.00 | 0.00 | 2.00 | 0.00 | 0.00 | 2.00 | 2.00 | 0.00 | 2.00 | 0.00 |
| Na2O | 15.00 | 12.50 | 11.10 | 15.00 | 15.00 | 11.29 | 11.79 | 11.36 | 5.00 | 5.04 |
| K2O | 0.00 | 0.00 | 4.00 | 4.00 | 2.20 | 3.08 | 1.62 | 4.00 | 4.00 | 3.96 |
| CaF2 | 0.29 | 0.24 | 0.14 | 0.19 | 0.00 | 0.16 | 0.24 | 0.40 | 0.40 | 0.40 |
| ZrO2 | 0.80 | 0.00 | 1.50 | 0.00 | 0.00 | 0.93 | 0.99 | 0.00 | 0.00 | 1.50 |
| Fe2O3 | 0.13 | 0.07 | 0.20 | 0.20 | 0.07 | 0.07 | 0.20 | 0.07 | 0.07 | 0.07 |
| TiO2 | 0.00 | 0.00 | 0.48 | 2.00 | 0.00 | 0.99 | 1.40 | 0.80 | 2.00 | 1.45 |
| V2O5 | 0.00 | 0.20 | 0.07 | 0.00 | 0.20 | 0.00 | 0.20 | 0.00 | 0.00 | 0.00 |
| Coke | 0.50 | 0.00 | 0.69 | 1.00 | 1.00 | 0.00 | 0.50 | 1.00 | 1.00 | 0.00 |
| SnO | 1.50 | 1.26 | 1.50 | 0.00 | 1.50 | 0.90 | 0.48 | 0.00 | 1.50 | 1.50 |
| SaltCake | 0.10 | 0.10 | 0.10 | 0.10 | 0.00 | 0.00 | 0.02 | 0.07 | 0.00 | 0.00 |
| Exp # | 51 | 52 | 53 | 54 | 55 | 56 | 57 | 58 | 59 | 60 |
| SiO2 | 55.31 | 56.73 | 59.78 | 53.52 | 60.00 | 74.70 | 62.09 | 72.14 | 69.23 | 65.69 |
| Al2O3 | 5.00 | 0.00 | 5.00 | 5.00 | 0.00 | 0.00 | 0.40 | 1.21 | 0.00 | 4.73 |
| MgO | 8.00 | 8.00 | 4.47 | 4.48 | 8.00 | 0.00 | 6.44 | 4.44 | 4.09 | 8.00 |
| CaO | 15.00 | 8.00 | 8.65 | 15.00 | 15.00 | 0.00 | 15.00 | 8.63 | 0.00 | 1.84 |
| SrO | 3.00 | 3.00 | 2.69 | 3.00 | 1.96 | 3.00 | 0.83 | 0.00 | 3.00 | 0.00 |
| BaO | 1.20 | 2.00 | 0.00 | 2.00 | 2.00 | 2.00 | 0.69 | 0.00 | 1.10 | 0.00 |
| Na2O | 10.16 | 15.00 | 12.39 | 15.00 | 5.00 | 15.00 | 6.65 | 12.89 | 15.00 | 14.98 |
| K2O | 0.00 | 4.00 | 4.00 | 0.00 | 4.00 | 4.00 | 3.14 | 0.00 | 4.00 | 0.00 |
| CaF2 | 0.40 | 0.40 | 0.22 | 0.00 | 0.00 | 0.00 | 0.20 | 0.00 | 0.25 | 0.33 |
| ZrO2 | 0.65 | 1.50 | 1.50 | 0.75 | 1.25 | 0.00 | 0.43 | 0.00 | 0.65 | 0.00 |
| Fe2O3 | 0.20 | 0.07 | 0.13 | 0.20 | 0.07 | 0.20 | 0.12 | 0.20 | 0.14 | 0.07 |
| TiO2 | 0.00 | 0.00 | 0.00 | 0.00 | 0.00 | 0.80 | 2.00 | 0.43 | 1.00 | 1.74 |
| V2O5 | 0.09 | 0.20 | 0.10 | 0.11 | 0.12 | 0.20 | 0.20 | 0.00 | 0.12 | 0.13 |
| Coke | 1.00 | 1.00 | 0.40 | 0.00 | 1.00 | 0.00 | 0.64 | 0.00 | 0.54 | 1.00 |
| SnO | 0.00 | 0.00 | 0.60 | 0.83 | 1.50 | 0.00 | 1.16 | 0.00 | 0.82 | 1.50 |
| SaltCake | 0.00 | 0.10 | 0.07 | 0.10 | 0.10 | 0.10 | 0.03 | 0.05 | 0.05 | 0.00 |
| Exp # | 61 | 62 | 63 | 64 | 65 | 66 | 67 | 68 | 69 | 70 |
| SiO2 | 64.04 | 62.68 | 58.23 | 70.70 | 70.99 | 71.19 | 53.40 | 68.03 | 54.87 | 64.07 |
| Al2O3 | 1.42 | 0.00 | 5.00 | 2.83 | 2.91 | 0.00 | 2.98 | 1.66 | 5.00 | 5.00 |
| MgO | 3.42 | 8.00 | 8.00 | 4.06 | 3.55 | 4.46 | 4.87 | 7.26 | 4.56 | 3.76 |
| CaO | 15.00 | 7.23 | 9.04 | 0.00 | 0.00 | 4.36 | 15.00 | 2.58 | 15.00 | 2.77 |
| SrO | 3.00 | 0.00 | 3.00 | 1.11 | 0.00 | 3.00 | 3.00 | 3.00 | 3.00 | 3.00 |
| BaO | 0.00 | 2.00 | 0.00 | 0.00 | 0.85 | 1.07 | 0.00 | 1.85 | 0.00 | 2.00 |
| Na2O | 9.31 | 15.00 | 11.62 | 15.00 | 15.00 | 10.60 | 15.00 | 11.60 | 10.29 | 15.00 |
| K2O | 0.00 | 2.11 | 1.43 | 4.00 | 2.52 | 1.91 | 1.60 | 2.60 | 1.64 | 0.00 |
| CaF2 | 0.00 | 0.20 | 0.40 | 0.40 | 0.40 | 0.20 | 0.21 | 0.25 | 0.00 | 0.00 |
| ZrO2 | 1.50 | 0.75 | 0.75 | 1.50 | 0.00 | 1.50 | 0.77 | 0.00 | 1.50 | 1.50 |
| Fe2O3 | 0.20 | 0.14 | 0.20 | 0.20 | 0.20 | 0.07 | 0.07 | 0.07 | 0.14 | 0.13 |
| TiO2 | 2.00 | 0.00 | 1.45 | 0.00 | 2.00 | 0.00 | 2.00 | 0.00 | 2.00 | 2.00 |
| V2O5 | 0.10 | 0.00 | 0.20 | 0.20 | 0.09 | 0.05 | 0.00 | 0.10 | 0.00 | 0.12 |
| Coke | 0.00 | 1.00 | 0.61 | 0.00 | 0.00 | 0.00 | 1.00 | 1.00 | 1.00 | 0.60 |
| SnO | 0.00 | 0.80 | 0.00 | 0.00 | 1.50 | 1.50 | 0.00 | 0.00 | 0.90 | 0.00 |
| SaltCake | 0.00 | 0.10 | 0.07 | 0.00 | 0.00 | 0.10 | 0.10 | 0.00 | 0.10 | 0.05 |

| Exp # | 71 | 72 | 73 | 74 | 75 | 76 | 77 | 78 |
|---|---|---|---|---|---|---|---|---|
| SiO2 | 65.33 | 61.17 | 61.32 | 74.38 | 58.89 | 69.07 | 51.57 | 56.99 |
| Al2O3 | 0.00 | 0.00 | 2.50 | 1.66 | 1.45 | 0.00 | 2.00 | 1.40 |
| MgO | 3.52 | 8.00 | 0.00 | 0.11 | 8.00 | 8.00 | 6.89 | 8.00 |
| CaO | 15.00 | 15.00 | 15.00 | 0.00 | 15.00 | 0.00 | 15.00 | 15.00 |
| SrO | 0.00 | 0.00 | 1.64 | 0.91 | 1.22 | 3.00 | 3.00 | 0.00 |
| BaO | 2.00 | 2.00 | 0.00 | 0.15 | 0.26 | 2.00 | 0.00 | 2.00 |
| Na2O | 9.00 | 5.58 | 15.00 | 15.00 | 6.61 | 9.53 | 11.11 | 15.00 |
| K2O | 0.00 | 4.00 | 0.00 | 4.00 | 4.00 | 4.00 | 4.00 | 0.00 |
| CaF2 | 0.40 | 0.00 | 0.40 | 0.13 | 0.34 | 0.40 | 0.17 | 0.00 |
| ZrO2 | 1.50 | 1.50 | 1.50 | 1.22 | 1.50 | 1.50 | 1.50 | 1.22 |
| Fe2O3 | 0.07 | 0.20 | 0.07 | 0.07 | 0.20 | 0.20 | 0.07 | 0.07 |
| TiO2 | 0.68 | 0.00 | 0.79 | 2.00 | 1.25 | 0.00 | 2.00 | 0.00 |
| V2O5 | 0.00 | 0.00 | 0.00 | 0.20 | 0.08 | 0.20 | 0.20 | 0.11 |
| Coke | 1.00 | 1.00 | 1.00 | 0.13 | 0.50 | 0.60 | 1.00 | 0.00 |
| SnO | 1.50 | 1.50 | 0.73 | 0.00 | 0.60 | 1.50 | 1.50 | 0.17 |
| SaltCake | 0.00 | 0.05 | 0.05 | 0.04 | 0.10 | 0.00 | 0.00 | 0.04 |

The optical data from these 78 experiments that were generated using DMC's D-Optimal logic showed transmittances at 95 individual wavelengths as well as the integrated results shown in the table 2 below. The results in this table are based on both JIS and ISO standards. The total UV is also indicated as T_{UV} measured according ISO standard ISO9050:1992.

TABLE 2

| | | | Selec- | | | Selec- | |
|---|---|---|---|---|---|---|---|
| Exp | VT | ST | tivity | VT | ST | tivity | |
| # | (ISO) | (ISO) | (ISO) | (JTS) | (JIS) | (JIS) | Tuv |
| 1 | 53.45 | 31.79 | 21.66 | 55.29 | 31.75 | 23.54 | 4.13 |
| 2 | 83.21 | 54.53 | 28.68 | 81.17 | 51.57 | 29.6 | 57.63 |
| 3 | 33.83 | 22.09 | 11.74 | 33.76 | 21.70 | 12.06 | 5.55 |
| 4 | 51.21 | 21.27 | 29.94 | 51.64 | 20.37 | 31.27 | 3.60 |
| 5 | 55.23 | 40.91 | 14.32 | 59.44 | 41.87 | 17.57 | 2.18 |
| 6 | 39.87 | 14.60 | 25.27 | 39.41 | 13.56 | 25.85 | 15.15 |
| 7 | 10.73 | 6.70 | 4.03 | 11.76 | 6.49 | 5.27 | 0.00 |
| 8 | 36.16 | 18.22 | 17.94 | 38.61 | 17.96 | 20.65 | 0.15 |
| 9 | 33.96 | 22.41 | 11.55 | 35.88 | 22.58 | 13.3 | 0.34 |
| 10 | 49.33 | 33.14 | 16.19 | 51.37 | 33.41 | 17.96 | 3.19 |
| 11 | 45.36 | 27.43 | 17.93 | 46.60 | 27.27 | 19.33 | 4.08 |
| 12 | 70.50 | 36.95 | 33.55 | 68.74 | 34.76 | 33.98 | 17.52 |
| 13 | 14.60 | 10.30 | 4.3 | 16.67 | 10.21 | 6.46 | 0.01 |
| 14 | 33.08 | 14.56 | 18.52 | 33.95 | 14.12 | 19.83 | 2.38 |
| 15 | 68.31 | 50.22 | 18.09 | 66.90 | 49.36 | 17.54 | 11.08 |
| 16 | 65.52 | 37.52 | 28 | 66.61 | 37.08 | 29.53 | 14.75 |
| 17 | 27.10 | 18.31 | 8.79 | 29.25 | 18.51 | 10.74 | 0.16 |
| 18 | 48.32 | 18.67 | 29.65 | 47.56 | 17.60 | 29.96 | 2.70 |
| 19 | 59.47 | 25.92 | 33.55 | 56.96 | 23.90 | 33.06 | 14.38 |
| 20 | 16.31 | 6.96 | 9.35 | 17.35 | 6.71 | 10.64 | 0.01 |
| 21 | 42.40 | 23.63 | 18.77 | 43.99 | 23.56 | 20.43 | 1.08 |
| 22 | 64.36 | 43.83 | 20.53 | 63.68 | 43.21 | 20.47 | 8.25 |
| 23 | 35.86 | 13.32 | 22.54 | 36.13 | 12.64 | 23.49 | 2.63 |
| 24 | 51.59 | 21.11 | 30.48 | 51.49 | 19.94 | 31.55 | 2.16 |
| 25 | 26.52 | 17.00 | 9.52 | 28.10 | 17.21 | 10.89 | 0.18 |
| 26 | 30.66 | 13.48 | 17.18 | 31.58 | 13.08 | 18.5 | 1.11 |
| 27 | 45.81 | 16.75 | 29.06 | 46.18 | 15.90 | 30.28 | 3.16 |
| 28 | 12.10 | 5.46 | 6.64 | 12.98 | 5.25 | 7.73 | 0.00 |
| 29 | 28.11 | 12.07 | 16.04 | 30.20 | 11.79 | 18.41 | 0.07 |
| 30 | 74.03 | 39.73 | 34.3 | 70.82 | 36.46 | 34.36 | 31.87 |
| 31 | 37.72 | 13.77 | 23.95 | 38.97 | 13.22 | 25.75 | 0.75 |
| 32 | 33.83 | 20.93 | 12.9 | 34.95 | 20.83 | 14.12 | 0.32 |
| 33 | 49.54 | 19.79 | 29.75 | 48.33 | 18.49 | 29.84 | 2.82 |
| 34 | 60.14 | 31.45 | 28.69 | 60.54 | 30.24 | 30.3 | 7.19 |
| 35 | 47.86 | 20.16 | 27.7 | 49.27 | 19.40 | 29.87 | 1.24 |
| 36 | 41.04 | 23.67 | 17.37 | 41.93 | 23.33 | 18.6 | 0.98 |
| 37 | 22.46 | 9.40 | 13.06 | 24.08 | 9.14 | 14.94 | 0.01 |
| 38 | 39.68 | 24.17 | 15.51 | 40.03 | 23.79 | 16.24 | 0.86 |
| 39 | 46.53 | 23.56 | 22.97 | 47.15 | 22.90 | 24.25 | 2.49 |
| 40 | 11.91 | 6.09 | 5.82 | 13.01 | 5.87 | 7.14 | 0.00 |
| 41 | 68.64 | 35.52 | 33.12 | 67.61 | 33.63 | 33.98 | 20.93 |
| 42 | 46.87 | 26.98 | 19.89 | 47.30 | 26.27 | 21.03 | 28.87 |
| 43 | 56.31 | 22.47 | 33.84 | 55.07 | 20.75 | 34.32 | 16.01 |
| 44 | 3.09 | 3.78 | −0.69 | 3.56 | 3.69 | −0.13 | 0.00 |
| 45 | 40.58 | 23.85 | 16.73 | 40.25 | 23.10 | 17.15 | 10.95 |
| 46 | 78.82 | 51.67 | 27.15 | 77.88 | 49.85 | 28.03 | 28.25 |
| 47 | 24.10 | 10.32 | 13.78 | 24.96 | 9.95 | 15.01 | 0.17 |
| 48 | 29.93 | 29.91 | 0.02 | 34.79 | 31.17 | 3.62 | 0.02 |
| 49 | 72.82 | 47.24 | 25.58 | 73.03 | 46.43 | 26.6 | 7.27 |
| 50 | 75.04 | 49.93 | 25.11 | 74.85 | 48.95 | 25.9 | 11.34 |
| 51 | 43.72 | 21.71 | 22.01 | 43.30 | 20.74 | 22.56 | 4.15 |
| 52 | 16.71 | 23.22 | −6.51 | 20.71 | 24.19 | −3.48 | 0.00 |
| 53 | 38.83 | 19.07 | 19.76 | 39.76 | 18.64 | 21.12 | 1.80 |
| 54 | 32.08 | 12.86 | 19.22 | 32.23 | 12.28 | 19.95 | 0.68 |
| 55 | 46.93 | 29.63 | 17.3 | 46.94 | 29.02 | 17.92 | 13.46 |
| 56 | 56.84 | 28.44 | 28.4 | 54.04 | 27.08 | 26.96 | 11.35 |
| 57 | 19.57 | 11.90 | 7.67 | 21.01 | 11.81 | 9.2 | 0.03 |
| 58 | 71.74 | 38.68 | 33.06 | 69.60 | 36.07 | 33.53 | 26.99 |
| 59 | 46.22 | 18.52 | 27.7 | 47.48 | 17.98 | 29.5 | 4.18 |
| 60 | 30.66 | 19.60 | 11.06 | 32.63 | 19.69 | 12.94 | 0.24 |
| 61 | 41.12 | 24.13 | 16.99 | 41.96 | 23.76 | 18.2 | 0.50 |
| 62 | 56.61 | 25.56 | 31.05 | 56.74 | 24.45 | 32.29 | 10.20 |
| 63 | 9.36 | 8.31 | 1.05 | 10.90 | 8.20 | 2.7 | 0.00 |
| 64 | 60.11 | 36.37 | 23.74 | 57.14 | 35.12 | 22.02 | 6.22 |
| 65 | 44.47 | 15.86 | 28.61 | 44.95 | 15.11 | 29.84 | 1.40 |
| 66 | 68.21 | 43.23 | 24.98 | 68.12 | 41.86 | 26.26 | 37.95 |
| 67 | 25.31 | 29.57 | −4.26 | 30.44 | 30.98 | −0.54 | 0.00 |
| 68 | 61.62 | 39.58 | 22.04 | 61.28 | 38.85 | 22.43 | 17.61 |
| 69 | 54.67 | 28.30 | 26.37 | 55.95 | 27.66 | 28.29 | 1.92 |
| 70 | 19.16 | 15.27 | 3.89 | 22.02 | 15.40 | 6.62 | 0.00 |
| 71 | 79.18 | 53.02 | 26.16 | 78.12 | 51.27 | 26.85 | 26.33 |
| 72 | 64.33 | 30.70 | 33.63 | 61.63 | 28.15 | 33.48 | 25.11 |
| 73 | 73.03 | 46.57 | 26.46 | 73.31 | 45.49 | 27.82 | 20.17 |
| 74 | 60.94 | 38.56 | 22.38 | 58.66 | 37.92 | 20.74 | 5.22 |
| 75 | 31.12 | 14.08 | 17.04 | 32.29 | 13.67 | 18.62 | 0.38 |
| 76 | 38.23 | 14.41 | 23.82 | 37.56 | 13.29 | 24.27 | 17.74 |
| 77 | 24.87 | 17.97 | 6.9 | 26.30 | 18.08 | 8.22 | 0.14 |
| 78 | 60.87 | 40.59 | 20.28 | 60.17 | 39.80 | 20.37 | 9.78 |

Each of these data points in the table are the averages of four slices of glass produced from each of the 78 melts based on the D-Optimal design of experiments.

Among these experiments, two glasses with extraordinary solar-optical properties were defined. The solar optical properties of the glass from Experiment #12 would be an outstanding candidate for residential glass with a visible transmission (ISO) in excess of 70% and corresponding solar transmission less than 37%.

The specific combination of ingredients in step 2 for this experiment was responsible for this extraordinary result.

It should be understood that some variations in the concentration of the ingredients may also produce similar results and that additions of other ingredients may be made without a major detrimental effect to the solar optical properties. Since the solar optical properties in this table and the tables below are so extraordinary, very good to excellent solar optical properties may be obtained which are still better than the commercial products with the elimination of one or more ingredients and/or the change in concentration of some ingredients by plus or minus 10%, 20% or even 50%. However, such modifications may also improve some other chemical, physical or mechanical property or improve melt-ability or manufacturing-ability. For example, different coloring compounds, refining agents and other compounds may be added to obtain certain color characteristics or improvements in the fining of the glass during manufacturing or the bending, tempering and fabricating characteristics. Whenever the specific combination of ingredients for any table is referenced in the sections below, the comments in this paragraph apply in every case.

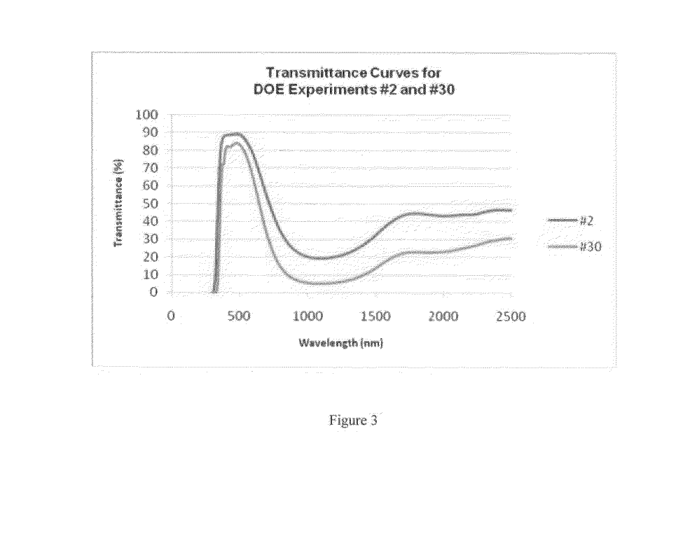

The solar optical properties of the glass from Experiment #30 would be an outstanding candidate for automotive glass with a visible transmission (ISO) in excess of 74% and corresponding solar transmission less than 40%. Results of this magnitude have never been reported or commercially available to the knowledge of the authors. The specific combination of ingredients in step 2 for this experiment was responsible for this extraordinary result. Two of the transmittance curves shown in FIG. 3 reflect the actual data that were analyzed at 95 individual wavelengths from 300 nm to 2500 nm. These two experimental results had the following VT and ST results as expressed in JIS and ISO metrics, shown in Table 3.

TABLE 3

| | Exp # 12 (JIS/ISO) | Exp # 30 (JIS/ISO) |
|---|---|---|
| VT | 68.7/70.5 | 70.8/74.0 |
| ST | 34.8/36.9 | 36.5/39.7 |

Over 1,000 regression models were examined using this logic with the Beer-Lambert Law as well as the Costin-Martin-Haller Law and data from the 78 DMC design. These results indicated that the Costin-Martin-Haller Law produced models that were superior to the Beer-Lambert Law models for fitting the transmittance curves.

The 95 models developed using the Costin-Martin-Haller Law using MSM with backward elimination all satisfied the follow rules, which are part of the HPGI modeling strategy.

All t-values for variables in the model were greater than the critical value, 2.0. All t-values for variables not in the model were less than the critical value 2.0

The ratio of the square root of the mean square error, S_{y.x}, to the experimental error, S_{experimental error}, is less than 1.7. This test demonstrates that the model prediction is not significantly different from the ability to melt the glass and measure the transmittance.

Comparison of the square root of the mean square errors at each wavelength indicated that the models developed using the Costin-Martin-Haller Law were sufficiently accurate for the application of NLPO to develop perturbation experiments to refine the data in the neighborhood of the indicated optimum batch chemistry.

NLPO runs performed by HPGI led to the following series of perturbation experiments to augment the DOE data in the regions of higher visible transmittance and test the ability of the model to predict. The perturbation experiments developed using NLPO are shown in the following table 4.

TABLE 4

| | Perturbations | | | | | |
|---|---|---|---|---|---|---|
| | Exp | Exp | Exp | Exp | Exp | Exp |
| | 2 - P1 | 2 - P2 | 2 - P3 | 12 -P1 | 12 - P3 | 12 - P4 |
| SiO2 | 67.41 | 67.36 | 69.49 | 68.20 | 68.98 | 69.70 |
| Al2O3 | 2.70 | 2.70 | 1.00 | 2.05 | 2.05 | 2.05 |
| MgO | 0.00 | 0.00 | 0.00 | 0.00 | 0.00 | 0.00 |
| CaO | 4.00 | 4.00 | 4.00 | 8.00 | 8.00 | 8.00 |
| SrO | 3.00 | 3.00 | 3.00 | 3.00 | 3.00 | 0.00 |
| BaO | 2.00 | 2.00 | 2.00 | 0.00 | 0.00 | 1.50 |
| Na2O | 15.00 | 15.00 | 15.00 | 15.00 | 15.00 | 15.00 |
| K2O | 4.00 | 4.00 | 4.00 | 0.00 | 0.00 | 0.00 |
| CeO2 | 0.50 | 0.50 | 0.00 | 0.00 | 0.00 | 0.00 |
| CaF2 | 0.00 | 0.00 | 0.00 | 0.00 | 0.00 | 0.00 |
| ZrO2 | 0.00 | 0.00 | 0.00 | 0.78 | 0.78 | 0.78 |
| Fe2O3 | 0.07 | 0.07 | 0.14 | 0.12 | 0.16 | 0.12 |
| TiO2 | 0.00 | 0.00 | 0.00 | 0.82 | 0.00 | 0.82 |
| V2O5 | 0.00 | 0.00 | 0.00 | 0.00 | 0.00 | 0.00 |
| Coke | 0.42 | 0.42 | 0.42 | 0.53 | 0.53 | 0.53 |
| SnO | 0.90 | 0.90 | 0.90 | 1.50 | 1.50 | 1.50 |
| SaltCake | 0.00 | 0.05 | 0.05 | 0.00 | 0.00 | 0.00 |
| | Perturbations | | | | | |
| | Exp | Exp | Exp | Exp | Exp | Exp |
| | 12 - P5 | 12 - P6 | 12 - P8 | 12 - P9 | 30 - P1 | 58 - P1 |
| SiO2 | 70.52 | 70.47 | 72.25 | 67.69 | 60.28 | 72.73 |
| Al2O3 | 2.05 | 2.05 | 0.00 | 2.05 | 1.00 | 1.00 |
| MgO | 0.00 | 0.00 | 0.00 | 0.00 | 0.00 | 0.00 |
| CaO | 8.00 | 8.00 | 8.00 | 8.00 | 15.00 | 8.63 |
| SrO | 0.00 | 0.00 | 0.00 | 3.00 | 3.00 | 0.00 |
| BaO | 1.50 | 1.50 | 1.50 | 0.00 | 0.80 | 0.00 |
| Na2O | 15.00 | 15.00 | 15.00 | 15.00 | 15.00 | 12.89 |
| K2O | 0.00 | 0.00 | 0.00 | 0.00 | 4.00 | 4.00 |
| CeO2 | 0.00 | 0.00 | 0.00 | 0.50 | 0.50 | 0.00 |
| CaF2 | 0.00 | 0.00 | 0.30 | 0.00 | 0.17 | 0.00 |
| ZrO2 | 0.78 | 0.78 | 0.78 | 0.78 | 0.00 | 0.00 |
| Fe2O3 | 0.12 | 0.12 | 0.14 | 0.13 | 0.20 | 0.20 |
| TiO2 | 0.00 | 0.00 | 0.00 | 0.82 | 0.00 | 0.00 |
| V2O5 | 0.00 | 0.00 | 0.00 | 0.00 | 0.00 | 0.00 |
| Coke | 0.53 | 0.53 | 0.53 | 0.53 | 0.00 | 0.00 |
| SnO | 1.50 | 1.50 | 1.50 | 1.50 | 0.00 | 0.50 |
| SaltCake | 0.00 | 0.05 | 0.00 | 0.00 | 0.05 | 0.05 |

The following results in tables 5 and 6 from the perturbation experiments listed above indicate actual VT and ST results both using the JIS (JIS-R3106:1998) and ISO (ISO9050:2003) standards.

TABLE 5

| JIS | VT actual | ST actual | Selectivity |
|---|---|---|---|
| Exp 2 - P1 | 81.55 | 52.05 | 29.51 |
| Exp 2 - P2 | 73.26 | 44.24 | 29.03 |
| Exp 2 - P3 | 66.28 | 30.83 | 35.46 |
| Exp 12 - P1 | 72.04 | 37.88 | 34.16 |
| Exp 12 - P3 | 71.73 | 36.17 | 35.55 |
| Exp 12 - P4 | 72.76 | 38.22 | 34.54 |
| Exp 12 - P5 | 75.61 | 41.48 | 34.13 |
| Exp 12 - P6 | 74.33 | 39.81 | 34.52 |
| Exp 12 - P8 | 73.48 | 38.36 | 35.12 |
| Exp 12 - P9 | 70.89 | 35.51 | 35.39 |
| Exp 30 - P1 | 74.23 | 42.90 | 31.33 |
| Exp 58 - P1 | 54.31 | 21.09 | 33.22 |

TABLE 6

| ISO | VT actual | ST actual | Selectivity |
|---|---|---|---|
| Exp 2 - P1 | 83.08 | 54.19 | 28.88 |
| Exp 2 - P2 | 71.67 | 44.85 | 26.82 |
| Exp 2 - P3 | 66.98 | 32.75 | 34.23 |
| Exp 12 - P1 | 73.71 | 40.27 | 33.44 |
| Exp 12 - P3 | 75.09 | 39.74 | 35.34 |
| Exp 12 - P4 | 74.50 | 40.69 | 33.81 |
| Exp 12 - P5 | 78.23 | 44.83 | 33.40 |
| Exp 12 - P6 | 76.42 | 42.79 | 33.62 |
| Exp 12 - P8 | 76.53 | 41.92 | 34.60 |
| Exp 12 - P9 | 72.56 | 37.58 | 34.98 |
| Exp 30 - P1 | 76.13 | 45.07 | 31.07 |
| Exp 58 - P1 | 53.53 | 22.26 | 31.27 |

Solar glasses from Experiment 2—P3, experiment 12—P1, Experiment 12—P3, Experiment 12—P4, Experiment 12—P6, Experiment 12—P8, Experiment 12—P9 in these tables show significant advancements from the glass industry standards with remarkably low solar transmissions for automotive glasses.

More generally, however, applicants have designed multiple uncoated glasses in which the visible transmission is greater than 69%, and solar transmissions less than 41%. These exceptional properties not obtained before are achieved from the specific combination of ingredients shown in tables above. Although the concentration of the ingredients may vary somewhat, the specific combination of the ingredients produce the exceptional results that cannot be obtained by examining the ranges of dopants and base glass ingredients and ranges because there are millions of possibilities and these specific combination of ingredients were found from optimization models to generate the solar optical properties never before achieved.

Also since uncoated residential glass with visible transmissions higher than automotive glass products typically do not have solar transmissions less than 60%, Experiment #2—P1 and Experiment #12—P5 show significant advancements in achieving extraordinarily low solar transmission.

The inventors recognized that a critical property overlooked in the glass industry is selectivity, which is the difference between the visible transmission and solar transmission. The best commercially available automotive glasses which have visible transmission of 69% and solar transmissions of 50% have a selectivity of 31.5. Surprisingly, the results from the perturbation numerous experiments reported in the table above reveal experiments with higher selectivity of 34.23, 33.44, 33.81, 33.40, 33.62, 34.60 and 34.98.

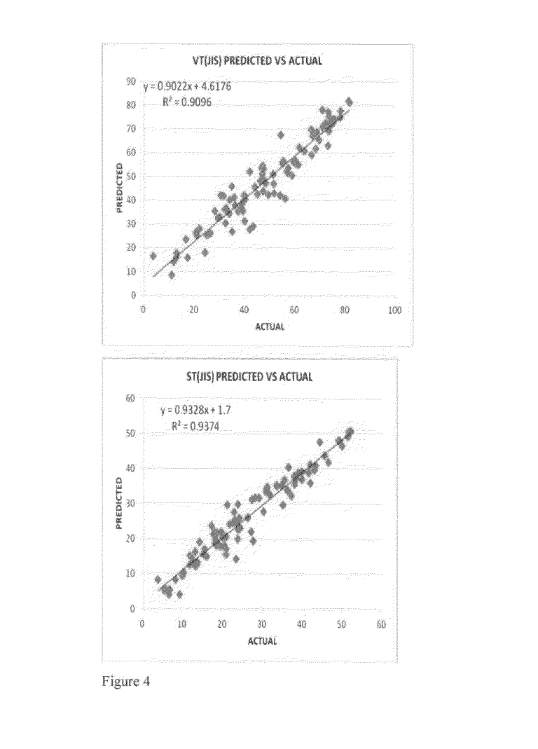

The 78 DOE experiments and the 12 perturbation experiments shown above were combined into a single data set for follow-up analysis using MSM to analyze the 95 transmittances and generate models for further NLPO runs relative to the development of high transmittance glasses in order to obtain the final model that HPGI felt was suitable for predictions and use in the NLPO. The final criterion prior to importing the results to NLPO is to integrate the model equations and compare the resulting predicted visible transmittance (VT) and solar transmittance (ST) with actual values. The results of these comparisons can be seen in the scatter diagrams in FIG. 4. The comparison of predicted VT and actual VT shown first is clearly linear. The square root of the mean square error, S_{y.x} is 5.6%. For predicted ST versus actual ST the result is also linear with an S_{y.x} of 3.1%.

In order to test whether ratio of the square root of the mean square error, Sy.x, to the experimental error, Sexperimental error, is less than 1.7, an estimate of experimental error is used. Multiple slices of the glass samples cut to the 4 mm thickness or multiple postions on a 4 mm slice of glass can be used to determine the instrument plus within melt variation. Then assuming the between melt variation is twice the within melt variation, the experimental error from an average of four slices can be estimated. The table 7 below indicates that the HPGI process in fact yielded models that can predict as well as the solar properties, VT and ST can be measured.

TABLE 7

| | VT(JIS) | VT(ISO) | ST(JIS) | ST(ISO) |
|---|---|---|---|---|
| S_{instrument+within melt} | 1.7 | 1.8 | 1.4 | 1.5 |
| S_{expt. error for 4 slices} | 3.5 | 3.8 | 3.0 | 3.0 |
| 1.7S_{expt.error for 4 slices} | 6.0 | 6.5 | 5.0 | 5.1 |
| S_{y.x-avg from correlation} | 5.6 | 5.6 | 3.1 | 3.1 |

The final step in the HPGI process was to use the MSM models for the 95 individual wavelengths for prediction using the NLPO software developed by HPGI to recommend 16 confirmation experiments. These are shown below in Table 8.

TABLE 8

| | Confirm | | | | | | |
|---|---|---|---|---|---|---|---|
| | Con. | Con. | Con. | Con. | Con. | Con. | Con. |
| | #2 | #3 | #4 | #5 | #6 | #7 | #8 |
| SiO2 | 71.96 | 70.02 | 70.81 | 70.74 | 75.00 | 70.20 | 71.58 |
| Al2O3 | 1.00 | 1.00 | 1.00 | 1.00 | 1.00 | 1.00 | 1.00 |
| MgO | 0.00 | 0.00 | 0.00 | 0.00 | 0.00 | 0.00 | 0.00 |
| CaO | 8.00 | 8.00 | 8.00 | 8.00 | 0.00 | 8.00 | 4.00 |
| SrO | 0.00 | 3.00 | 3.00 | 3.00 | 1.89 | 3.00 | 0.00 |
| BaO | 1.50 | 0.00 | 0.00 | 0.00 | 2.00 | 0.00 | 3.00 |
| Na2O | 15.00 | 15.00 | 15.00 | 15.00 | 14.54 | 15.00 | 15.00 |
| K2O | 0.00 | 0.00 | 0.00 | 0.00 | 3.43 | 0.00 | 4.00 |
| CeO2 | 0.00 | 0.00 | 0.00 | 0.00 | 0.00 | 0.40 | 0.00 |
| CaF2 | 0.30 | 0.00 | 0.00 | 0.00 | 0.06 | 0.00 | 0.00 |
| ZrO2 | 0.00 | 0.00 | 0.00 | 0.00 | 0.00 | 0.00 | 0.00 |
| Fc2O3 | 0.16 | 0.13 | 0.16 | 0.18 | 0.20 | 0.17 | 0.10 |
| TiO2 | 0.00 | 0.82 | 0.00 | 0.00 | 0.00 | 0.20 | 0.00 |
| V2O5 | 0.00 | 0.00 | 0.00 | 0.00 | 0.00 | 0.00 | 0.00 |
| Coke | 0.53 | 0.53 | 0.53 | 0.53 | 0.50 | 0.53 | 0.42 |
| SnO | 1.50 | 1.50 | 1.50 | 1.50 | 1.33 | 1.50 | 0.90 |
| SaltCake | 0.05 | 0.00 | 0.00 | 0.05 | 0.05 | 0.00 | 0.00 |
| | Confirm | | | | | | |
| | Con. | Con. | Con. | Con. | Con. | Con. | Con. |
| | #9 | #10 | #12 | #13 | #14 | #15 | #16 |
| SiO2 | 72.50 | 72.50 | 75.00 | 72.50 | 75.00 | 72.50 | 74.30 |
| Al2O3 | 0.50 | 0.50 | 0.50 | 0.50 | 0.50 | 0.50 | 0.50 |
| MgO | 2.52 | 0.00 | 0.00 | 0.00 | 0.00 | 3.58 | 0.00 |
| CaO | 0.00 | 4.07 | 0.00 | 6.93 | 0.00 | 0.00 | 0.00 |
| SrO | 1.84 | 2.31 | 2.11 | 1.47 | 1.38 | 0.98 | 0.97 |
| BaO | 5.00 | 3.00 | 3.00 | 2.00 | 2.00 | 5.00 | 3.00 |
| Na2O | 12.00 | 12.00 | 15.00 | 12.00 | 14.69 | 12.00 | 13.94 |
| K2O | 3.00 | 3.00 | 0.00 | 3.00 | 4.00 | 3.00 | 4.00 |
| CeO2 | 0.00 | 0.00 | 0.49 | 0.00 | 0.00 | 0.00 | 0.40 |
| CaF2 | 0.37 | 0.40 | 0.30 | 0.22 | 0.34 | 0.40 | 0.33 |
| ZrO2 | 0.00 | 0.00 | 0.00 | 0.00 | 0.00 | 0.00 | 0.00 |
| Fe2O3 | 0.20 | 0.20 | 0.20 | 0.20 | 0.20 | 0.20 | 0.20 |
| TiO2 | 0.21 | 0.00 | 0.85 | 0.00 | 0.00 | 0.05 | 1.19 |
| V2O5 | 0.00 | 0.00 | 0.00 | 0.00 | 0.00 | 0.00 | 0.00 |
| Coke | 0.50 | 0.50 | 1.00 | 0.00 | 0.50 | 0.50 | 0.00 |
| SnO | 1.30 | 1.47 | 1.50 | 1.18 | 1.35 | 1.24 | 1.17 |
| SaltCake | 0.05 | 0.05 | 0.05 | 0.00 | 0.05 | 0.05 | 0.00 |

The mole concentration of the slack variable, SiO2, varies from about 70 to about 75% for these confirmation experiments. These confirmation experiments were based on study of NLPO runs using the MSM models developed using the Costin-Martin-Haller Law of transmittance for each wavelength using the steps outlined in the modeling sections described above.

The results of the confirmation experiments are shown in the table 9 below.

TABLE 9

| | | | Selec- | | | Selec- | |
|---|---|---|---|---|---|---|---|
| | VT | ST | tivity | VT | ST | tivity | |
| Confirm | (ISO) | (ISO) | (ISO) | (JIS) | (JIS) | (JIS) | Tuv |
| Con. #2 | 72.13 | 36.49 | 35.64 | 69.77 | 33.53 | 36.24 | 35.33 |
| Con. #3 | 73.93 | 39.49 | 34.44 | 71.90 | 36.87 | 35.03 | 22.99 |
| Con. #4 | 76.13 | 40.46 | 35.67 | 72.57 | 36.71 | 35.86 | 47.60 |
| Con. #5 | 70.29 | 34.32 | 35.97 | 67.61 | 31.36 | 36.25 | 33.17 |
| Con. #6 | 72.15 | 34.94 | 37.21 | 68.78 | 31.57 | 37.21 | 37.30 |
| Con. 6A | 72.3 | 35.1 | 37.2 | | | 0 | |
| Con. #7 | 73.65 | 36.80 | 36.85 | 70.29 | 33.71 | 36.58 | 14.98 |
| Con. #8 | 81.57 | 48.57 | 33 | 79.08 | 45.15 | 33.93 | 54.22 |
| Con. #9 | 68.52 | 31.95 | 36.57 | 65.68 | 29.06 | 36.62 | 28.49 |
| Con. #10 | 69.26 | 32.78 | 36.48 | 66.54 | 29.83 | 36.71 | 32.11 |
| Con. #12 | 67.54 | 30.3 | 37.24 | 65.04 | 27.92 | 37.12 | 7.48 |
| Con. #13 | 72.13 | 36.49 | 35.64 | 69.97 | 33.53 | 36.44 | 35.33 |
| Con. #14 | 72.71 | 35.30 | 37.41 | 69.41 | 31.93 | 37.48 | 37.37 |
| Con. #15 | 69.40 | 32.88 | 36.52 | 66.35 | 29.80 | 36.55 | 33.43 |
| Con. #16 | 68.54 | 31.14 | 37.4 | 66.00 | 28.65 | 37.35 | 9.08 |

Confirmation experiments #2-#7 reveal absolute breakthroughs in minimizing the solar transmission for automotive glass where the minimum visible transmission of 70% is required. For example, the solar transmission of Confirmation experiment #6 is remarkably less than 35% (ISO)—an unprecidented result never realized before in any study, patent or commercially available glass. Even more surprising was this unprecidented level of solar optical properties were achieved with a beautiful blue green color of the glass. This most unusual result, in and by itself, is a major breakthrough since very high redox glasses tend to retain SO3 which produces a somewhat undesirable olive or brown color. This is particularly true in the case for the very high redox glasses (>90%) for some of the confirmation experiments.

According to one embodiment, the blue-green color can be a color defined as 87.94 L*, −28.99 a*, 94.61 b* and dominant wavelength of 490.73.

Another embodiment, therefore, produces a high redox glass of this type, with less than 0.2% SO₃, more preferably less than 0.1% SO₃.

The specific combination of ingredients described above for this confirmation experiment contributed to this extraordinary result. Again, it should be understood that some variations in the concentration of the ingredients may also produce similar results and that additions/modifications of other ingredients may be made without a major detrimental effect to the solar optical properties. Since the solar optical properties in this table and the tables below are so extraordinary, very good to excellent solar optical properties may be obtained which are still better than the commercial products with the elimination of one or more ingredients and/or the change in concentration of some ingredients by +/−10%, 20%, 30% or 50%. However, such modifications may also improve some other chemical, physical or mechanical property or improve melt-ability or manufacturing-ability. For example, different coloring compounds, refining agents and other compounds may be added to obtain certain color characteristics or improvements in the fining of the glass during manufacturing or the bending, tempering and fabricating characteristics.

As an example, Confirm 6A shows that elimination of the fluorine ingredient decreases the solar-optical properties, but only marginally. If it is more desirable to manufacture a fluorine-free melt, than Confirm 6A still represents an unprecidented breakthrough in the achievement of solar optical properties of 72% VT and 35% ST at a most attractive blue color.

Similarly, Confirmation experiment #8 reveals an absolute breakthrough in minimizing the solar transmission for residential window glass with a visible transmission of 81% and a solar transmission of 49% (ISO).

Selectivity, as described above, is the visible transmission minus the solar transmission. Greater selectivity is better, since the spread between the solar and visible means that the glass is very visible, but not solar-transmitting. Another feature of these glasses is the high selectivity. Amazingly, the selectivity of each one of the confirmation experiments is greater than the commercial standard of 30 with selectivity ranges from 33.00 to about 37.21. Again, results of this nature have never before been realized for an uncoated glass.

As in the case for several of the perturbation experiments, the confirmation experiments show exceptional solar optical properties not obtained ever before and are achieved from the specific combination of ingredients shown in the tables above. Although the concentration of the ingredients may vary somewhat, the specific combination of the ingredients produce the exceptional results that cannot be obtained by examining the ranges of dopants and base glass ingredients and ranges because there are millions of possibilities and these specific combination of ingredients were found from optimization models to generate the solar optical properties never before achieved.

HPGI's Non Linear Property Optimizer (NLPO) was further used to generate sensitivity analyses. This can be used to understand how each ingredient in the glass would change the solar optical properties upon small changes in its concentration. The NLPO sensitivity analysis is dependent upon the batch composition which is selected. So, for the NLPO batch composition 15.0 Na20, 2.84 K20, 0 MgO, 0 Cao, 1.84 Sro, 2.00 BaO, 0.18 CaF2, 1.00 Al2O3, 0.20 Fe2O3, 0 TiO2, 0 ZrO2, .001 V2O5, 0.5 C, 1.366 SnO2, .05 SaltCake, 0 CeO2 and 75.00 SiO2, sensitivity analyses revealed the following:
A. Reducing the Barium oxide from 2 to 1 reduces
   VT and selectivity
B. Increasing Barium oxide from 2 to 3 increases
   VT and selectivity (although this is outside the range studied)
C. Reducing SrO from 1.8 to 1 has little effect
D. Reducing SrO to 0 has little effect
E. Increasing MgO above 0 decreases VT and selectivity
F. Reducing CaF2 to 0 reduces VT and ST with slight reduction in selectivity
G. Reducing Al2O3 from 1 to 0.5 makes slight improvement to VT and selectivity
H. Increasing Al2O3 from 1 to 2 lowers both VT and selectivity
I. Reducing Fe2O3 from 0.2 to 0.18 increases ST and decreases selectivity
J. Increasing Fe2O3 from 0.2 to 0.22 decreases VT and slighty reduced selectivity so that 0.2 Fe2O3 may be a sweet spot
K. Increasing TiO2 from 0 to 0.5 reduces VT, ST and selectivity
L. Increasing ZrO2 from 0 to 0.5 has little effect
M. Reducing V2O5 from 0.0091 to 0 increases VT and selectivity
N. Reducing SnO from 1.36 to 1.0 reduces VT and selectivity indicating the critical need for SnO
O. Reducing Saltcake from 0.05 to 0 improves VT and significantly improves selectivity indicating that other refining agents should be considered due to the negative effect of SaltCake
P. Adding 0.05 CeO2 has amall effect on VT, ST and selectivity for this specific batch composition but significantly reduces UV

The complete batch compositional ranges for the perturbation experiments and confirmation experiments which delivered relatively high visible transmission and relatively low solar transmission and in most cases selectivity unequaled in the flat glass industry is shown in the table 10 below:

TABLE 10
Batch Compositional Ranges for Hi VT Low ST Experiments

| | |
|---|---|
| Perturbation | Confirmation |
| Experiments | Experiments |

| | Minimum | Maximum | Minimum | Maximum |
|---|---|---|---|---|
| SiO2 | 60.28 | 72.73 | 70.02 | 75 |
| Na2O | 12.89 | 15 | 12 | 15 |
| K2O | 0 | 4 | 0 | 4 |
| MgO | 0 | 0 | 0 | 3.58 |
| CaO | 4 | 15 | 0 | 8 |
| SrO | 0 | 3 | 0 | 3 |
| BaO | 0 | 2 | 0 | 5 |
| CaF2 | 0 | 0.3 | 0 | 0.4 |
| Al2O3 | 0 | 2.7 | 0.5 | 1 |
| Fe2O3 | 0.07 | 0.2 | 0.1 | 0.2 |
| TiO2 | 0 | 0.82 | 0 | 0.82 |
| ZrO2 | 0 | 0.78 | 0 | 0 |
| V2O5 | 0 | 0 | 0 | 0 |
| Coke | 0 | 0.53 | 0 | 1 |
| SnO | 0 | 1.5 | 0.9 | 1.5 |
| SalltCake | 0 | 0.05 | 0 | 0.05 |
| CeO2 | 0 | 0.5 | 0 | 0.49 |

The glass chemistry was also obtained and compared to the batch chemistry.

The table 11 below shows the comparison of the batch chemistry to the glass chemistry for the measured thirteen confirmation experiments in weight percent. Every one of these confirmation experiments achieved solar-optical properties never before realized in the industry.

TABLE 11

| | Batch | Glass | Batch | Glass | Batch | Glass | Batch | Glass |
|---|---|---|---|---|---|---|---|---|
| | #2 | #2 | #3 | #3 | #4 | #4 | #5 | #5 |
| SiO2 | 68.6 | 68.12 | 66.9 | 66.40 | 67.8 | 66.98 | 67.7 | 66.77 |
| Al2O3 | 1.6 | 1.64 | 1.6 | 1.81 | 1.6 | 1.65 | 1.6 | 1.65 |
| MgO | 0 | 0 | 0 | 0 | 0 | 0 | 0 | 0 |
| CaO | 7.1 | 7.70 | 7.1 | 7.44 | 7.1 | 7.44 | 7.1 | 7.39 |
| SrO | 0 | 0.01 | 4.9 | 5.43 | 5 | 5.36 | 4.9 | 5.37 |
| BaO | 3.7 | 3.83 | 0 | 0 | 0 | 0 | 0 | 0 |
| Na2O | 14.8 | 15.49 | 14.8 | 15.15 | 14.8 | 15.06 | 14.8 | 15.41 |
| K2O | 0 | 0.01 | 0 | 0 | 0 | 0 | 0 | 0 |
| CeO2 | 0 | 0 | 0 | 0 | 0 | 0 | 0 | 0 |
| CaF2 | 0.4 | 0 | 0 | 0 | 0 | 0 | 0 | 0 |
| ZrO2 | 0 | 0 | 0 | 0 | 0 | 0 | 0 | 0 |
| Fc2O3 | 0.41 | 0.44 | 0.33 | 0.36 | 0.41 | 0.46 | 0.46 | 0.50 |
| TiO2 | 0 | 0 | 1.04 | 1.08 | 0 | 0 | 0 | 0 |
| V2O5 | 0 | 0 | 0 | 0 | 0 | 0 | 0 | 0 |
| Coke | 0.1 | 0 | 0.1 | 0 | 0.1 | 0 | 0.1 | 0 |
| SnO | 3.21 | 2.74 | 3.21 | 2.33 | 3.22 | 3.06 | 3.21 | 2.91 |
| SO3* | 0.11 | 0.01 | 0 | 0 | 0 | 0 | 0.11 | 0.01 |

| | Batch | Glass | Batch | Glass | Batch | Glass |
|---|---|---|---|---|---|---|
| | #6 | #6 | #7 | #7 | #8 | #8 |
| SiO2 | 68.6 | 69.04 | 66.6 | 66.21 | 65.8 | 64.72 |
| Al2O3 | 1.6 | 1.61 | 1.6 | 1.69 | 1.6 | 1.57 |
| MgO | 0 | 0 | 0 | 0 | 0 | 0 |
| CaO | 0 | 0 | 7.1 | 7.39 | 3.4 | 3.54 |
| SrO | 3 | 3.31 | 4.9 | 5.37 | 0 | 0.01 |
| BaO | 4.7 | 5.01 | 0 | 0.28 | 7 | 7.43 |
| Na2O | 13.7 | 13.44 | 14.7 | 15.21 | 14.2 | 14.59 |
| K2O | 4.9 | 5.20 | 0 | 0 | 5.8 | 6.12 |
| CeO2 | 0 | 0 | 1.1 | 1.17 | 0 | 0 |
| CaF2 | 0.1 | 0 | 0 | 0 | 0 | 0 |
| ZrO2 | 0 | 0 | 0 | 0 | 0 | 0 |
| Fe2O3 | 0.49 | 0.56 | 0.43 | 0.47 | 0.24 | 0.28 |
| TiO2 | 0 | 0 | 0.25 | 0 | 0 | 0 |
| V2O5 | 0 | 0 | 0 | 0 | 0 | 0 |
| Coke | 0.09 | 0 | 0.1 | 0 | 0.08 | 0 |
| SnO | 2.74 | 1.82 | 3.19 | 2.21 | 1.85 | 1.73 |
| SO3* | 0.11 | 0.01 | 0 | 0 | 0 | 0 |
| | Batch | Glass | Batch | Glass | Batch | Glass |
| | #9 | #9 | #10 | #10 | #12 | #12 |
| SiO2 | 64.4 | 64.00 | 65.7 | 64.60 | 68.3 | 67.49 |
| Al2O3 | 0.8 | 0.75 | 0.8 | 0.75 | 0.8 | 0.77 |
| MgO | 1.5 | 1.68 | 0 | 0 | 0 | 0 |
| CaO | 0 | 0.32 | 3.4 | 3.90 | 0 | 0.25 |
| SrO | 2.8 | 2.97 | 3.6 | 3.85 | 3.3 | 3.55 |
| BaO | 11.3 | 11.54 | 6.9 | 7.35 | 7 | 7.39 |
| Na2O | 11 | 11.53 | 11.2 | 11.69 | 14.1 | 14.55 |
| K2O | 4.2 | 4.41 | 4.3 | 4.47 | 0 | 0.00 |
| CeO2 | 0 | 0 | 0 | 0 | 1.3 | 1.34 |
| F | 0.4 | 0.13 | 0.5 | 0.27 | 0.4 | 0.30 |
| ZrO2 | 0 | 0 | 0 | 0 | 0 | 0 |
| Fe2O3 | 0.47 | 0.51 | 0.48 | 0.52 | 0.48 | 0.53 |
| TiO2 | 0.25 | 0.23 | 0 | 0 | 1.03 | 1.09 |
| V2O5 | 0 | 0 | 0 | 0 | 0 | 0 |
| Coke | 0.09 | 0 | 0.09 | 0 | 0.18 | 0 |
| SnO | 2.6 | 1.92 | 2.98 | 2.59 | 3.06 | 2.73 |
| SO3* | 0.11 | 0.01 | 0.11 | 0.01 | 0.11 | 0.01 |
| | Batch | Glass | Batch | Glass | Batch | Glass |
| | #13 | #13 | #14 | #14 | #15 | #15 |
| SiO2 | 67.1 | 65.78 | 68.8 | 69.43 | 65.1 | 64.15 |
| Al2O3 | 0.8 | 0.76 | 0.8 | 0.78 | 0.8 | 0.74 |
| MgO | 0 | 0 | 0 | 0 | 2.2 | 2.44 |
| CaO | 6 | 6.33 | 0 | 0.33 | 0 | 0.34 |
| SrO | 2.4 | 2.51 | 2.2 | 2.42 | 1.5 | 1.61 |
| BaO | 4.7 | 4.78 | 4.7 | 5.14 | 11.5 | 12.00 |
| Na2O | 11.5 | 12.00 | 13.9 | 13.50 | 11.1 | 11.74 |
| K2O | 4.4 | 4.56 | 5.8 | 6.00 | 4.2 | 4.44 |
| CeO2 | 0 | 0 | 0 | 0 | 0 | 0 |
| F | 0.3 | 0.22 | 0.4 | 0.15 | 0.5 | 0.16 |
| ZrO2 | 0 | 0 | 0 | 0 | 0 | 0 |
| Fe2O3 | 0.49 | 0.53 | 0.48 | 0.54 | 0.48 | 0.52 |
| TiO2 | 0 | 0 | 0 | 0 | 0.06 | 0 |
| V2O5 | 0 | 0 | 0 | 0 | 0 | 0 |
| Coke | 0 | 0 | 0.09 | 0 | 0.09 | 0 |
| SnO | 2.46 | 2.53 | 2.77 | 1.69 | 2.5 | 1.84 |
| SO3* | 0 | 0.00 | 0.11 | 0.01 | 0.11 | 0.01 |

*as Na2SO4 in case of Batch (SO3 concentration in case of Glass)

Finally, the color characteristics of the glass from the perturbation experiments and the confirmation experiments were measured and shown below. It is particularly noteworthy that Confirmation experiment #6 showed a beautiful blue green color that the authors believe would be highly desirable in the marketplace for both homes and automobiles.

TABLE 12

| | L* | a* | b* | Dw |
|---|---|---|---|---|
| Exp 2- P1 | 93.01 | −21.73 | −96.81 | 487.99 |
| Exp 2- P2 | 87.80 | −24.29 | −45.97 | 572.21 |
| Exp 2- P3 | 85.43 | −30.07 | −57.78 | 563.09 |
| Exp 12- P1 | 88.72 | −26.71 | −82.30 | 523.10 |
| Exp 12- P3 | 89.35 | −26.95 | −99.76 | 487.74 |
| Exp 12- P4 | 89.10 | −26.63 | −83.60 | 516.14 |
| Exp 12- P5 | 90.82 | −24.98 | −97.91 | 488.33 |
| Exp 12- P6 | 89.99 | −26.33 | −88.67 | 503.26 |
| Exp 12- P8 | 90.02 | −25.73 | −99.88 | 487.33 |
| Exp 12- P9 | 88.17 | −28.27 | −77.81 | 540.90 |
| Exp 30- P1 | 89.87 | −24.50 | −91.13 | 494.35 |
| Exp 58- P1 | 78.14 | −30.51 | −18.94 | 569.46 |
| Confirm #2 | 87.95 | −28.75 | −84.13 | 509.90 |
| Confirm #3 | 88.82 | −26.98 | −85.71 | 503.92 |
| Confirm #4 | 89.83 | −26.56 | −102.74 | 486.47 |
| Confirm #5 | 87.04 | −29.86 | −84.49 | 502.11 |
| Confirm #6 | 87.94 | −28.99 | −94.61 | 490.73 |
| Confirm #7 | 88.67 | 27.91 | −97.24 | 489.15 |
| Confirm #8 | 92.33 | −23.76 | −100.61 | 486.53 |
| Confirm #9 | 86.16 | −30.48 | −84.33 | 502.89 |
| Confirm #10 | 86.54 | −30.08 | −84.13 | 502.62 |
| Confirm #12 | 85.68 | 30.89 | −79.27 | 511.20 |
| Confirm #13 | 88.80 | −27.47 | −104.33 | 486.08 |
| Confirm #14 | 88.22 | −28.77 | −94.54 | 490.92 |
| Confirm #15 | 86.60 | −30.20 | −87.57 | 497.07 |
| Confirm #16 | 86.19 | −30.14 | −82.78 | 502.93 |

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other formulas can be used.

In fact the following additional formulations are within the invention.

### Example 1

A high visible, low solar transmission glass product made from a glass batch composition that has in mole percent:

75.0% SiO2

14.54% Na2O

3.43% K2O

1.89% SrO

2.00% BaO

0.06% CaF2

1.00% Al2O3

0.20% Fe2O3

0.50% Coke

1.33% SnO

0.05% Saltcake

This can have a visible transmission in excess at 71% and a total solar transmission less than 36% at 4 mm glass thickness, and a blue green external color, e.g., 86-92 L*, −27 to −30 a*, −90 to −100b* and dominant wavelength of 480-510 nm.

The glass batch composition can also have an addition of less than 0.1% CeO2. It can also have additional minor ingredients less than 1% selected from the list comprising:

CaO, MgO, TiO2, ZrO2, V2O5, MnO, Se, P2O₅, Bi2O3.

Any of these values can be varied by plus or minus 25% in one embodiment.

### Example 2

A high visible, low solar transmission glass product made from glass batch composition ranges comprising in mole percent:

60-78% SiO2

11-20% Na2O

0-10% K2O

0-18% CaO

0-10% SrO

0-15% BaO

0-5% ZrO2

0-1% CaF2

0-2.6% Al2O3

0-12% MgO

0.05-1% Fe2O3

0-0.9% TiO2

0-0.6% Coke

0-5% SnO

0-0.08% Saltcake

0-5% CeO2

and V2O5 is free;
wherein further comprising a visible transmission in excess of 69% and a selectivity defined by a difference between a visible transmission and a solar transmission of greater than 31.5 at 4 mm glass thickness and using ISO measurement.

The glass batch composition of Example 2 can have any additional minor ingredients less than 1% selected from the list comprising, MnO, Se, P2O5, Bi2O3.

The glass batch composition of Example 2 further comprising a UV transmission less than 16% at 4 mm glass thickness, wherein CeO2 is 0.1-1%.

### Example 3

The glass batch composition of Example 2, wherein the glass composition ranges comprising in mole percent:

65-78% SiO2

0-4% MgO

0-0.7% TiO

0.1-5% SnO

Example 3 can produce a glass batch composition range that a visible transmission in excess of 75%.

Example 3 can produce a glass batch composition range that the selectivity is greater than 34.5.

Example 3 can produce a glass batch composition range that the solar transmission is less than 36.5% in the case of the visible transmission equal to 72% by adjusting glass thickness.

### Example 4

A high visible, low solar transmission glass product made from glass batch composition ranges comprising in mole percent:

67-76% SiO2

11-16% Na2O

0-5% K2O

0-16% CaO

0-5% SrO

0-6% BaO

0-1% ZrO2

0-1% CaF2

0-2.2% Al2O3

0-4% MgO

0.05-0.3% Fe2O3

0-0.5% TiO2

0-0.6% Coke

0.5-2% SnO

0-0.06% Saltcake

0-1% CeO2

and V2O5 is free;
wherein further comprising a solar transmission is less than 36.5% in the case of the visible transmission equal to 72% by adjusting glass thickness and using ISO measurement.

### Example 5

A high visible, low solar transmission glass product made from a glass composition comprising in weight percent:

69.0% SiO2

13.0% Na2O

5.2% K2O

3.3% SrO

5.0% BaO

1.6% Al2O3

0.56% Fe2O3

1.8% SnO

0.01% SO3

In one embodiment, these individual ingredients might vary by plus or minus 25%.

The glass of this embodiment has a visible transmission in excess at 71% and a total solar transmission less than 36% at 4 mm glass thickness.

The glass can have a blue green external color, e.g, a color at around 87.94 L*, −28.99 a*, 94.61 b* and dominant wavelength of 490.73.

### Example 6

A high visible, low solar transmission glass product made from glass composition ranges comprising in weight percent:

55-75% SiO2

11.6-20.0% Na2O

0-10% K2O

0-15% CaO

0-10% SrO

0-15% BaO

0-5% ZrO2

0.01-4.0% Al2O3

0-10% MgO

0.1-1.0% Fe2O3

0-1.2% TiO2

0-5% SnO

0-5% CeO2

and having a fluorine concentration of 0-1% and a sulfur trioxide concentration of 0-0.02%, and V2O5 is free;
wherein Fe2O3+TiO2 is 0.23-1.60%.

The glass composition of Example 6 further comprising a visible transmission in excess at 69% and a selectivity defined by a difference between a visible transmission and a solar transmission of greater than 31.5 at 4 mm glass thickness and using ISO measurement.

The glass composition of Example 6 further comprising a UV transmission less than 16% at 4 mm glass thickness, wherein the CeO2 is 0.5-2%.

### Example 7

The glass composition of Example 6, wherein the glass composition ranges comprising in weight percent:

60-75% SiO2

0-2.5% MgO

0-1.1% TiO

0.1-5% SnO

The glass composition of Example 7 further comprising a visible transmission in excess at 75% and a selectivity defined by a difference between a visible transmission and a solar transmission of greater than 31.5 at 4 mm glass thickness and using ISO measurement.

The glass composition of Example 7 further comprising a visible transmission in excess at 69% and a selectivity defined by a difference between a visible transmission and a solar transmission of greater than 34.5 at 4 mm glass thickness and using ISO measurement.

### Example 8

The glass composition of Example 7, wherein the TiO is 0-1.0% in weight percent.

The glass composition of Example 8 further comprising a solar transmission less than 36.5% in the case of a visible transmission equal to 72% by adjusting glass thickness and using ISO measurement.

### Example 9

A high visible, low solar transmission glass product made from glass composition ranges comprising in weight percent:

60-75% SiO2

11.6-18.0% Na2O

0-8% K2O

0-15% CaO

0-8% SrO

0-15% BaO

0-3% ZrO2

0.01-4.0% Al2O3

0-2.5% MgO

0.1-0.8% Fe2O3

0-1.0% TiO2

0.5-4% SnO

0-3% CeO2

and having a fluorine concentration of 0-0.5% and a sulfur trioxide concentration of 0-0.02%, and V2O5 is free;
wherein Fe2O3+TiO2 is 0.23-1.50%, and
wherein further comprising a solar transmission is less than 36.5% in the case of the visible transmission equal to 72% by adjusting glass thickness and using ISO measurement.

### Example 10

This describes a method to achieve a glass product with a high visible transmission greater than 69% and low solar transmission less than 41% for 4 mm glass. This is done by

Melting a glass batch with:

Selected mother glass ingredients: SiO2, Na2O, K2O and CaO

Selected enhancements to the mother glass ingredients: MgO, BaO and SrO

Selected compounds for IR absportion: Fe2O3

Selected weather resistant ingredients: Al2O3

Selected redox agents: Coke, SnO

Selected refining agents: Saltcake

Selected minor ingredients: TiO2, ZrO2, MnO, Se, P2O5, Bi2O3, CeO2.

Glass batch composition ranges for the mother glass ingredients of 60-78% SiO2, 11-20% Na2O, 0-10% K2O, 0-18% CaO; and

Glass batch composition ranges for the mother glass enhancement ingredients of 0-12% MgO, 0-10% SrO, 0-15% BaO

Glass batch composition ranges for compounds for IR absorption: 0.05-1% Fe2O3

Glass batch composition ranges for the weather resistance ingredients of 0-2.6% Al2O3

Glass batch composition ranges for the redox ingredients of 0-0.6% Coke and 0-5% SnO

Glass batch composition ranges for the refining ingredients of 0-0.06% Saltcake

Glass batch composition ranges for selected minor ingredients of 0-1%

### Example 11

This describes a method to achieve a glass product with an ultra high visible transmission greater than 75% and low solar transmission less than 50% for 4 mm glass comprising:

Melting a glass batch with:

Selected mother glass ingredients: SiO2, Na2O, K2O and CaO

Selected enhancements to the mother glass ingredients: MgO, BaO and SrO

Selected compounds for IR absportion: Fe2O3

Selected weather resistant ingredients: Al2O3

Selected redox agents: Coke, SnO

Selected refining agents: Saltcake

Selected UV absorbers: CeO2

Selected color shift dopants: CaF2

Selected minor ingredients: TiO2, ZrO2, MnO, Se, P2O5, Bi2O3.

The glass can comprise in mole percent:

Glass batch composition ranges for the mother glass ingredients of 65-78% SiO2, 11-20% Na2O, 0-10% K2O, 0-16% CaO; and

Glass batch composition ranges for the mother glass enhancement ingredients of 0-4% MgO, 0-10% SrO, 0-15% BaO

Glass batch composition ranges for compounds for IR absorption: 0.05-1% Fe2O3

Glass batch composition ranges for the weather resistance ingredients of 0-2.6% Al2O3

Glass batch composition ranges for the redox ingredients of 0-0.6% Coke and 0.1-5% SnO

Glass batch composition ranges for the refining ingredients of 0-0.08% Saltcake

Glass batch composition ranges for UV absorption: 0-5% CeO2

Glass batch composition ranges for color shift dopants: 0-1% CaF2

Glass batch composition ranges for selected minor ingredients of 0-1%

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, display port, or any other form. This may include laptop or desktop computers, and may also include portable computers, including cell phones, tablets such as the IPAD™, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non transitory computer based instructions. An exemplary storage medium is coupled to the processor such that the processor can read information from, and write information to, the storage medium. In the alternative, the storage medium may be integral to the processor. The processor and the storage medium may reside in reconfigurable logic of any type.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A glass material, formed to have a modeled transmittance at each specified wavelengths, according to the relation:
$$T ( λ ) = {\sum }_{i = 1}^{m} {β ( λ )}_{i} {c}_{i} + {\sum }_{i = 1}^{m} {β ( λ )}_{ii} {c}_{i}^{2} + {\sum }_{i = 1}^{m} {\sum }_{j > i}^{m} {β ( λ )}_{ij} {c}_{i} {c}_{j}$$
Where, T(λ) is the transmittance at a specified wavelength, β's are the unknown absorber factors and the c's are the known concentrations of each compound from the batch chemistry, where there are m different compound.

2. The glass material as in claim 1, wherein said glass material has a visible transmission greater than 69%, and a solar transmission less than 41% for 4 mm glass and using ISO measurement.

3. The glass material as in claim 2, wherein said glass material has a blue-green color.

4. The glass material as in claim 3, wherein said blue-green color is a color blue green external color, in the range of 86-92 L*, −27 to −30 a*, and −90 to −100b*.

5. The glass material as in claim 3, wherein said blue-green color has a dominant wavelength between 480-510 nm.

6. The glass material as in claim 2, wherein said glass has an amount of CeO2 less than 0.5%.

7. The glass material as in claim 1, where β is based on and includes information about both an amount of absorption of a specific compound in the glass material and a distance that the light passes through the glass material.

8. The glass material as in claim 1, wherein said glass has a visible transmission greater than 75% and a solar transmission less than 50%.

9. The glass material as in claim 2, wherein said glass has a selectivity defined by a difference between a visible transmission and a solar transmission of greater than 31.5.

10. The glass material as in claim 8, wherein said glass has a selectivity defined by a difference between a visible transmission and a solar transmission of greater than 34.5.

11. The glass material as in claim 1, manufactured from glass batch compounds include all of Na2O, K2O, SrO, BaO, Al2O3, Fe2O3, Coke, SnO and SaltCake.

12. The glass material as in claim 11, wherein said compounds further include at least one of MgO and CaO.

13. The glass material as in claim 1, manufactured from glass batch comprising Na2O, K2O and CaO, and also includes a first material for infrared absorption, a second material for weather resistance, a third material for redox adjustment, a fourth material as a refining agent, and at least one minor material.

14. The glass material as in claim 13, wherein said first material includes Fe2O3 with redox agents in an amount effective to enhance infrared absorption.

15. The glass material as in claim 13, wherein said second material includes Al2O3 in an amount effective to enhance weather resistance.

16. The glass material as in claim 13, wherein said third material includes at least one of coke or SnO in an amount effective to effect redox.

17. The glass material as in claim 13, wherein said fourth material includes Saltcake in an amount effective to refine the glass.

18. The glass material as in claim 13, wherein said minor materials include at least one of: CaO, MgO, TiO2, ZrO2, V2O5, MnO, Se, P2O5, Bi2O3.

19. The glass material as in claim 3, wherein said glass has less than 0.1% SO3.

20. A high visible, low solar transmission glass product made from glass batch composition ranges comprising in mole percent:
60-78% SiO2
11-20% Na2O
0-10% K2O
0-18% CaO
0-10% SrO
0-15% BaO
0-5% ZrO2
0-1% CaF2
0-2.6% Al2O3
0-12% MgO
0.05-1% Fe2O3
0-0.9% TiO2
0-0.6% Coke
0-5% SnO
0-0.08% Saltcake
0-5% CeO2
and V2O5 is free;
wherein further comprising a visible transmission in excess of 69% and a selectivity defined by a difference between a visible transmission and a solar transmission of greater than 31.5 at 4 mm glass thickness and using ISO measurement.

21. The glass batch composition ranges of claim 20 with any additional minor ingredients less than 1% selected from the list comprising: MnO, Se, P2O5, Bi2O3.

22. The glass batch composition of claim 20, wherein the glass composition ranges comprising in mole percent:
65-78% SiO2
0-4% MgO
0-0.7% TiO
0.1-5% SnO

23. The glass batch composition range of claim 22, wherein the visible transmission is in excess of 75%.

24. The glass batch composition range of claim 22, wherein the selectivity is greater than 34.5.

25. The glass batch composition range of claim 22, wherein the solar transmission is less than 36.5% in the case of the visible transmission equal to 72% by adjusting glass thickness.

26. The glass batch composition of claim 20 further comprising a blue green external color.

27. The glass batch composition of claim 20 further comprising a UV transmission less than 16% at 4 mm glass thickness, wherein CeO2 is 0.1-1%.

28. A high visible, low solar transmission glass product made from glass composition ranges comprising in weight percent:
55-75% SiO2
11.6-20.0% Na2O
0-10% K2O
0-15% CaO
0-10% SrO
0-15% BaO
0-5% ZrO2
0.01-4.0% Al2O3
0-10% MgO
0.1-1.0% Fe2O3
0-1.2% TiO2
0-5% SnO
0-5% CeO2
and having a fluorine concentration of 0-1% and a sulfur trioxide concentration of 0-0.02%, and V2O5 is free;
wherein Fe2O3+TiO2 is 0.23-1.60%.

29. The glass composition of claim 28 further comprising a visible transmission in excess at 69% and a selectivity defined by a difference between a visible transmission and a solar transmission of greater than 31.5 at 4 mm glass thickness and using ISO measurement.

30. The glass composition of claim 28, wherein the glass composition ranges comprising in weight percent:
60-75% SiO2
0-2.5% MgO
0-1.1% TiO
0.1-5% SnO

31. The glass composition of claim 30 further comprising a visible transmission in excess at 75% and a selectivity defined by a difference between a visible transmission and a solar transmission of greater than 31.5 at 4 mm glass thickness and using ISO measurement.

32. The glass composition of claim 30 further comprising a visible transmission in excess at 69% and a selectivity defined by a difference between a visible transmission and a solar transmission of greater than 34.5 at 4 mm glass thickness and using ISO measurement.

33. The glass composition of claim 30, wherein the TiO is 0-1.0% in weight percent.

34. The glass composition of claim 33 further comprising a solar transmission less than 36.5% in the case of a visible transmission equal to 72% by adjusting glass thickness and using ISO measurement.

35. The glass composition of claim 28 further comprising a blue green external color.

36. The glass composition of claim 28 further comprising a UV transmission less than 16% at 4 mm glass thickness, wherein the CeO2 is 0.5-2%.

37. A method to achieve a glass product with a high visible transmission greater than 69% and low solar transmission less than 41% for 4 mm glass comprising:
Melting a glass batch with:
Selected mother glass ingredients: SiO2, Na2O, K2O and CaO
Selected enhancements to the mother glass ingredients: MgO, BaO and SrO
Selected compounds for IR absportion: Fe2O3
Selected weather resistant ingredients: Al2O3
Selected redox agents: Coke, SnO
Selected refining agents: Saltcake
Selected minor ingredients: TiO2, ZrO2, MnO, Se, P2O5, Bi2O3, CeO2.

38. The method of claim 37 further comprising in mole percent:
Glass batch composition ranges for the mother glass ingredients of 60-78% SiO2, 11-20% Na2O, 0-10% K2O, 0-18% CaO; and
Glass batch composition ranges for the mother glass enhancement ingredients of 0-12% MgO, 0-10% SrO, 0-15% BaO
Glass batch composition ranges for compounds for IR absorption: 0.05-1% Fe2O3
Glass batch composition ranges for the weather resistance ingredients of 0-2.6% Al2O3
Glass batch composition ranges for the redox ingredients of 0-0.6% Coke and 0-5% SnO
Glass batch composition ranges for the refining ingredients of 0-0.08% Saltcake
Glass batch composition ranges for selected minor ingredients of 0-1%

39. A method to achieve a glass product with an ultra high visible transmission greater than 75% and low solar transmission less than 50% for 4 mm glass comprising:
Melting a glass batch with:
Selected mother glass ingredients: SiO2, Na2O, K2O and CaO
Selected enhancements to the mother glass ingredients: MgO, BaO and SrO
Selected compounds for IR absportion: Fe2O3
Selected weather resistant ingredients: Al2O3
Selected redox agents: Coke, SnO
Selected refining agents: Saltcake
Selected UV absorbers: CeO2
Selected color shift dopants: CaF2
Selected minor ingredients: TiO2, ZrO2, MnO, Se, P2O5, Bi2O3.

40. The method of claim 39 further comprising in mole percent:
Glass batch composition ranges for the mother glass ingredients of 65-78% SiO2, 11-20% Na2O, 0-10% K2O, 0-18% CaO; and
Glass batch composition ranges for the mother glass enhancement ingredients of 0-4% MgO, 0-10% SrO, 0-15% BaO
Glass batch composition ranges for compounds for IR absorption: 0.05-1% Fe2O3
Glass batch composition ranges for the weather resistance ingredients of 0-2.6% Al2O3
Glass batch composition ranges for the redox ingredients of 0-0.6% Coke and 0.1-5% SnO
Glass batch composition ranges for the refining ingredients of 0-0.08% Saltcake
Glass batch composition ranges for UV absorption: 0-5% CeO2
Glass batch composition ranges for color shift dopants: 0-1% CaF2
Glass batch composition ranges for selected minor ingredients of 0-1%
